(19) United States
(12) Patent Application Publication
(10) Pub. No.: US 2017/0017758 A1
(43) Pub. Date: Jan. 19, 2017

(54) INTEGRATED SYSTEM FOR OBTAINING INFORMATION FROM ELECTRONIC MEDICAL RECORDS AND METHOD OF USE

(71) Applicant: INFUSYSTEM HOLDINGS, INC., Madison Heights, MI (US)

(72) Inventors: Michael Milton McReynolds, Lawrence, KS (US); Jean Raniere Pfeiffer, Santa Barbara, CA (US)

(21) Appl. No.: 15/130,707

(22) Filed: Apr. 15, 2016

Related U.S. Application Data
(60) Provisional application No. 62/147,849, filed on Apr. 15, 2015.

(51) Int. Cl. G06F 19/00; G06F 17/30

(52) U.S. Cl. CPC G06F 19/322; G06F 19/3456; G06F 19/328; G06F 17/30424

(57) ABSTRACT

An electronic system including a data collection system, a tracking system, and a locating system, is provided. The data collection system is integrated with an Electronic Medical Records system and includes a search and retrieval algorithm. The search and retrieval algorithm includes logic for obtaining a second set of information based on a first set of information obtained from data feeds of the Electronic Medical Records system. The information is utilized by the tracking system to determine whether a piece of medical equipment is needed and to send a signal to a user of the system when a particular piece of equipment is no longer required. The locating system is utilized to determine the current location of the piece of equipment and to send a signal to the user of the system if the piece of equipment is removed from a designated area of the hospital.

### CROSS-REFERENCE TO RELATED APPLICATIONS

This application claims priority pursuant to 35 U.S.C. 119(e) to co-pending U.S. Provisional Patent Application Ser. No. 62/147,849, filed Apr. 15, 2015, the entire disclosure of which is incorporated herein by reference.

### FIELD OF THE INVENTION

The present invention relates generally to information data systems. More specifically, the present invention is concerned with data systems that are integrated with Electronic Medical Records.

### BACKGROUND OF THE INVENTION

Although a massive amount of information is saved in electronic systems, such as Electronic Medical Records, much of this information is highly protected and/or otherwise difficult to obtain. Furthermore, even when the information is available, it can be difficult or expensive to sift through the large amount of information to determine whether any of the information is useful and/or necessary for a particular purpose. Consequently, it would be beneficial to have a data collection system that is integrated with an information system, such as Electronic Medical Records. Furthermore, it would be beneficial if the data collection system included a search and retrieval algorithm and/or some other mechanism to increase the efficiency of reviewing and obtaining information from the information system. Furthermore still, it would be beneficial if the search and retrieval algorithm was capable of obtaining information pertaining to medical equipment.

Although medical equipment, such as infusion pumps, are expensive and are critical for saving lives, medical equipment is routinely misplaced and/or lost. In many cases, lost and/or misplaced equipment is attributable to the sheer size of the hospitals within which the medical equipment is used. In other cases, it is attributable to the personnel responsible for the equipment being too busy caring for patients and/or coordinating other important tasks. As a result, even the relatively simple task of informing someone when equipment is no longer required may be postponed and/or forgotten all together. And the longer the equipment stays in a particular area, the more likely the equipment will be misplaced, lost, or even stolen. Furthermore, even if a piece of equipment is found, it is not readily apparent where the equipment has been and if the equipment has potentially been contaminated. Consequently, it would be beneficial to have a tracking system that is capable of utilizing information from Electronic Medical Records to assist equipment owners in determining when a particular piece of medical equipment is no longer needed and/or where a particular piece of medical equipment is most likely located. Furthermore, it would be beneficial if the tracking system was capable of providing a user of the system with information pertaining to whether the particular piece of equipment has been contaminated or not and/or whether the particular piece of equipment potentially contaminated one or more other pieces of equipment.

In addition to obtaining information from Electronic Medical Records, it would also be beneficial to have a locating system that includes a location mechanism, such as a transponder and a map. It would further be beneficial if the location of the equipment was automatically updated on the map so that a user of the system could determine the present location of a particular piece of equipment simply by observing the map. It would still further be beneficial if the tracking system included an indicator and/or a warning if a particular piece of equipment was removed from a predetermined area of the map so that a user of the system would be alerted if the piece of equipment was about to be misplaced and/or stolen.

### SUMMARY OF THE INVENTION

The present invention comprises an electronic system that generally includes a computer program, and one or more data storage devices in data communication with one or more data processors and one or more user interfaces. In various embodiments, the present invention includes a data collection system, a tracking system, and/or a locating system. In this way, various embodiments of the system and methods of the present invention are capable of generating and/or processing prescriptions and/or physician work orders; determining an inventory of, a current availability of, and/or a current need for one or more prescription drugs and/or piece of medical equipment; and/or locating one or more prescription drug and/or piece of medical equipment.

### INFUBUS™

The present invention includes a data collection system and a method of collecting data from an established system so as to obtain information from one or more data sources of the established system. The data collection system comprises one or more data storage devices in data communication with one or more data processors and one or more user interfaces. In some embodiments, the user interface is a mobile device, such as a smartphone or a tablet. The data collection system is capable of programmatically gathering a variety of information from at least one data source, such as electronic medical records (“EMR”). In some embodiments, the data collection system is integrated with the established system and/or with the at least one data source. In a preferred embodiment, the data collection system utilizes a proprietary integration engine to integrate with the data source and to filter the data.

### INFUTRACK™

The present invention also includes a tracking system for and method of tracking equipment, such as medical equipment. The tracking system comprises one or more data storage devices in data communication with one or more data processors and one or more user interfaces. In some embodiments, the user interface is a mobile device, such as a smartphone or a tablet.

In some embodiments of the present invention, a user links a particular piece of equipment, such as an infusion pump, with a particular user of the equipment, such as a patient. In some such embodiments, the tracking system receives information from the integration system so as to track the use of the equipment and/or to determine when the equipment is no longer needed. For instance, in some embodiments, the tracking system tracks the movement of a piece of equipment assigned to a patient by tracking the movement of the patient as the patient is moved throughout a medical facility. In other embodiments, the system alerts a user when a piece of equipment assigned to a patient is no longer needed by the patient, such as when a treatment regimen requiring the equipment is complete, the patient is released from the hospital, and/or the patient dies.

### INFULOCATE™

The present invention also includes a locating system for and method of locating equipment, such as medical equipment. The locating system comprises one or more data storage devices in data communication with one or more data processors and one or more user interfaces. In some embodiments, the user interface is a mobile device, such as a smartphone or a tablet. In some embodiments, a transponder is coupled to the equipment and a receiver is in data communication with at least one data processor. In some such embodiments, the transponder and receiver are each configured such that the transponder is capable of sending a signal that the receiver is capable of receiving. In other such embodiments, the transponder is pinged to determine the location of the equipment. In still other such embodiments, the transponder sends out an alert if the equipment is removed from a pre-determined area, such as a hospital facility. It will be appreciated that although a transponder and a receiver are specifically mentioned, it is contemplated that a variety of means of determining the location of one or more pieces of equipment can be utilized without changing the spirit or scope of the present invention.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, various embodiments of the present technology include a variety of combinations and/or integrations of the embodiments described herein.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a graphic showing various EMR Message Triggers for a preferred embodiment of the present invention.

FIG. 2 is a flow chart for PWO creation for a preferred embodiment of the present invention.

FIG. 3 includes flow charts for PWO creation for a preferred embodiment of the present invention.

FIG. 4 is a flow chart for ADT Processing for a preferred embodiment of the present invention.

FIG. 5 is a flow chart for RDE Processing for a preferred embodiment of the present invention.

FIG. 6A is a flow chart for DFT Processing for a preferred embodiment of the present invention.

FIG. 6B is a flow chart for DFT Patient Processing for a preferred embodiment of the present invention.

FIG. 6C is a flow chart for DFT Physician Processing for a preferred embodiment of the present invention.

FIG. 7 is a flow chart for adding a treatment for a preferred embodiment of the present invention.

FIG. 8A is a flow chart for an inserted treatment for a preferred embodiment of the present invention.

FIG. 8B is a flow chart for an inserted treatment for an additional preferred embodiment of the present invention.

FIG. 9 is a flow chart for establishing a PWO effective date for a preferred embodiment of the present invention.

FIG. 10A is a first portion of a flow chart for creating a treatment for a preferred embodiment of the present invention.

FIG. 10B is a second portion of a flow chart for creating a treatment for the preferred embodiment of FIG. 10A.

FIG. 10C is an alternative portion of the flow chart shown in FIGS. 10A and 10B.

FIG. 11A is a first portion of a flow chart for creating a treatment for an additional preferred embodiment of the present invention.

FIG. 11B is a second portion of a flow chart for creating a treatment for the additional preferred embodiment of FIG. 11A.

FIG. 12A is flow chart containing logic pertaining to whether a serial number needs to be assigned to a treatment for a preferred embodiment of the present invention.

FIG. 12B includes alternative logic for the flow chart of FIG. 13A.

FIG. 13 is a flow chart pertaining to an ordering physician for a preferred embodiment of the present invention.

FIG. 14 is a visual representation of various features of a preferred embodiment of the present invention.

FIGS. 15-21 show various flow charts showing various features of various embodiments of the present invention.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

In various embodiments, the present invention comprises a system for and a method of collecting data, tracking items, and/or locating items. In some embodiments, the system is a paperless system for generating and/or processing information associated with prescriptions and/or physician work orders. In other embodiments, the system is a paperless system for instantaneously determining an inventory of, a current availability of, and/or a current need for one or more prescription drugs and/or one or more piece of medical equipment, such as medical equipment that is reasonably required and/or otherwise useful for the administration of the one or more prescription drugs. In still other embodiments, the system is capable of providing real-time location information of a piece of equipment, such as medical equipment.

### INFUBUS™

Preferred embodiments of the present invention includes a data collection system and a method of collecting data from an established system so as to obtain information directly from one or more data sources of the established system. In some embodiments, at least some of the information in the data source is confidential and/or access to the data source is limited. In some such embodiments, the system includes a method of securely monitoring a large amount of information for limited purposes, such as determining whether a patient needs a particular piece of medical equipment and/or where in a hospital the particular piece of medical equipment is currently located. If some such information is detected, the system retrieves information that is reasonably necessary for the need to be fulfilled and/or the location to be determined. In this way, a user of the system is able to obtain necessary information from the data source without acquiring additional information that is not necessary, thereby avoiding potential hassles associated with the acquisition of such additional information.

In a preferred embodiment, the data collection system of the present invention is integrated with an EMR system in order to automatically receive one or more data feeds such as an Admission/Discharge/Transfer (“ADT”) data feed, a Pharmacy/Treatment Encoded Order (“RDE”) data feed, a Detailed Financial Transactions (“DFT”) data feed, or the like. In some embodiments, the data collection system includes a search and retrieval algorithm that is capable of sifting through the data feeds to find specific information. When the specific information is found, the search and retrieval algorithm utilizes the specific data to determine if additional information is needed and what the additional information may be. The search and retrieval algorithm then searches the data feeds and/or other data repositories for the additional information and pulls the additional information directly from the data feed and/or other data repository.

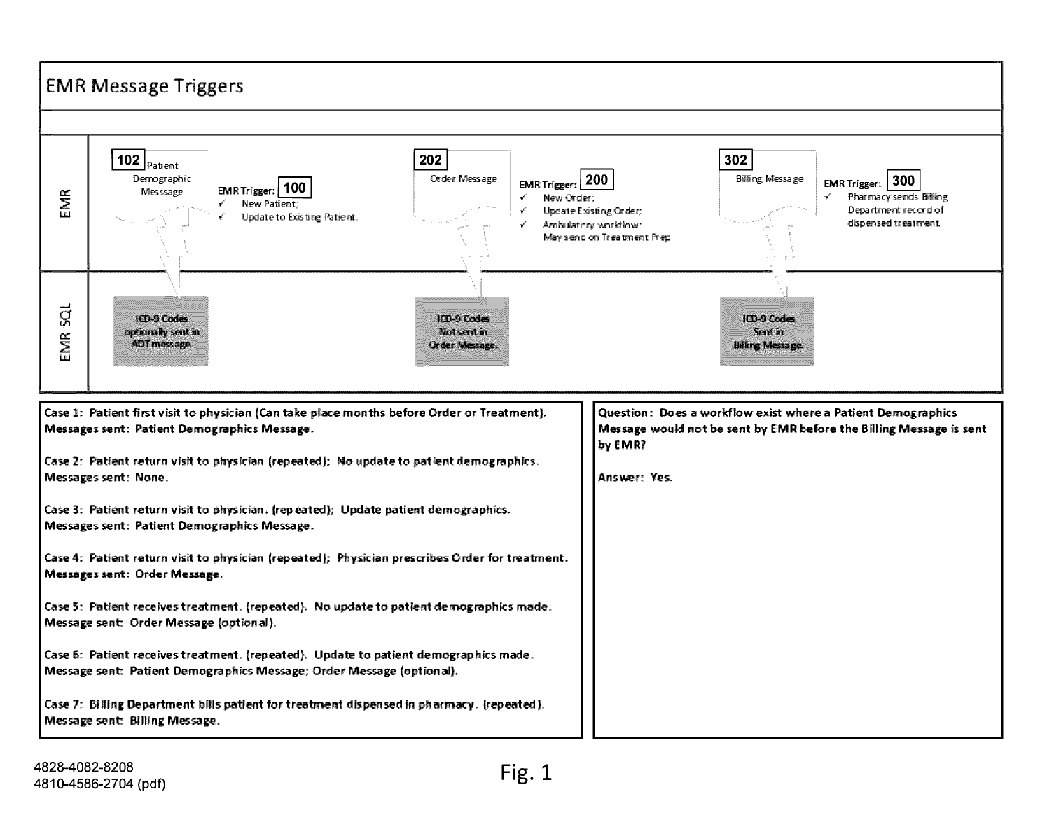

Referring to FIG. 1. one or more EMR is updated with information, such as adding or updating patient information 100, adding or updating treatment information 200, and/or adding or updating financial information 300, such as billing or payment information. In some such embodiments, these updates serve as trigger events for the present invention to obtain additional information. For instance, when patient information 100 is added or updated, a Patient Demographics and/or ADT Message 102 generated by the EMR system triggers the present invention to obtain additional information, such as information pertaining to the patient; when treatment and/or prescription information 200 is added or updated, an Order and/or RDE Message 202 generated by the EMR system triggers the present invention to obtain additional information, such as information pertaining to the order and/or the physician who signed the order; and/or when financial information 300 is added or updated, a Billing and/or DFT Message 302 generated by the EMR system triggers the present invention to obtain additional information, such as information pertaining to the order and/or the patient.

The data collection system further includes a logic algorithm. In some embodiments, the logic algorithm sifts through information that is received by the search and retrieval algorithm so as to determine steps to be taken. For instance, if the retrieved information includes information suggesting that patient information 100, such as a patient's demographic data and/or the patient's insurance data, has been added or changed, the logic algorithm determines that a patient record 52 should be created and/or updated within a database 50 of the system. As another example, if the retrieved information includes treatment information 200 that indicates that a particular piece of medical equipment is needed, such as a prescription order indicating a drug that requires the use of the medical equipment, the logic algorithm saves the pertinent portion of the treatment information 200 into a database 50 by creating and/or updating a patient record 52, a treatment record 54, a financial record and/or a facility record 56.. As still another example, if the retrieved information includes financial information 300 that indicates that a patient has been charged for the purchase and/or rental of a particular piece of medical equipment, the logic algorithm saves the financial information into a database 50 by creating and/or updating a patient record 52, an equipment record 54, and/or a facility record 56.

In some embodiments, the data collection system obtains information pertaining to one or more facility and/or one or more physician such that the system is able to determine whether a particular prescription and/or Physician's Written Order (“PWO”) affects a particular facility and/or whether the particular prescription and/or PWO was signed by a physician with authority to sign such a prescription and/or PWO. In some such embodiments, the system generates an electronic PWO for a physician to sign. In other such embodiments, the system stores information pertaining to signed PWO's and/or signed prescriptions.

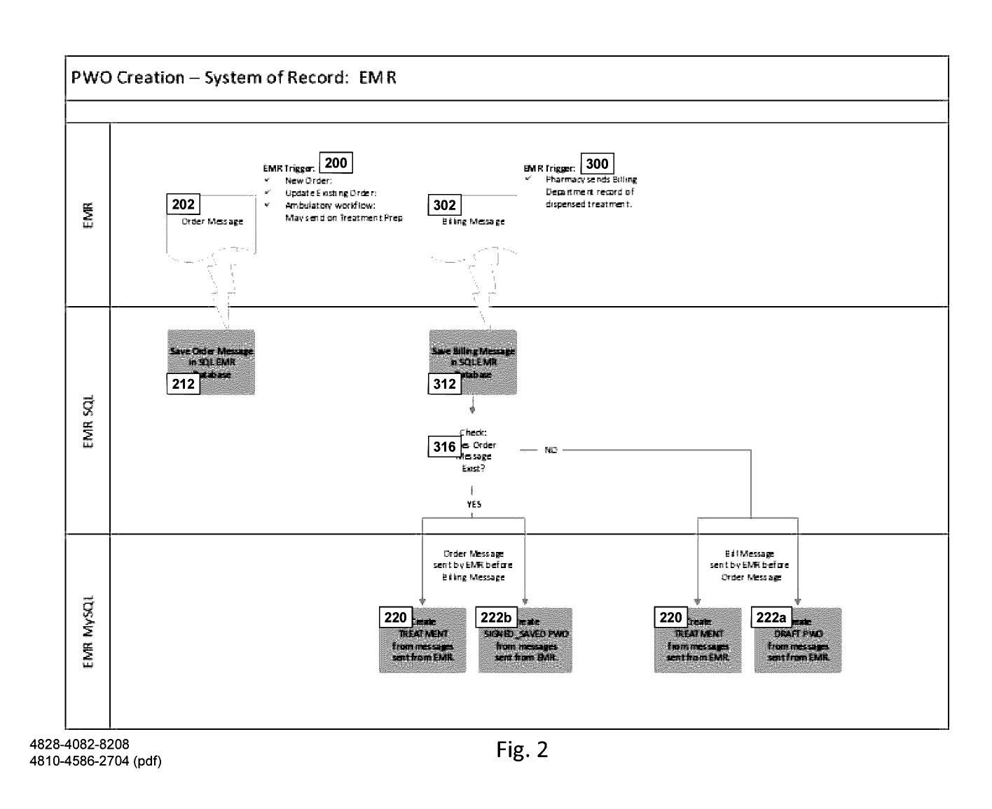

Referring to FIG. 2, various methods of the present invention include obtaining 210 by the data collection system 10 all or part of an RDE Message 202, the RDE Message 202 being generated by an EMR system in response to new or updated treatment information 200. Some methods further include saving 212 all or part of the RDE Message 202 into a database 50 of the data collection system 10.

Still referring to FIG. 2, various other methods of the present invention include obtaining 310 by the data collection system 10 all or part of a DFT Message 302, the DFT Message 302 being generated by an EMR system in response to new or updated financial information 300. Some methods further include saving 312 all or part of the DFT Message 302 into a database 50 of the data collection system 10. Other methods include checking 316 a database 50 of the data collection system 10 for corresponding RDE information, such as whether a corresponding RDE Message 202 has been obtained by the system 10. In some such methods where a corresponding RDE information has not been obtained by the system 10, the system 10 creates 220 a treatment and/or creates 222a a Draft PWO. In other such methods where a corresponding RDE information has been obtained by the system 10, the system 10 creates 220 a treatment and/or creates 234 a Signed PWO. It will be appreciated that in some embodiments creating a treatment includes creating and/or saving a treatment protocol; creating and/or updating a Patient Record 52; and/or creating and/or updating a Treatment Record 53.

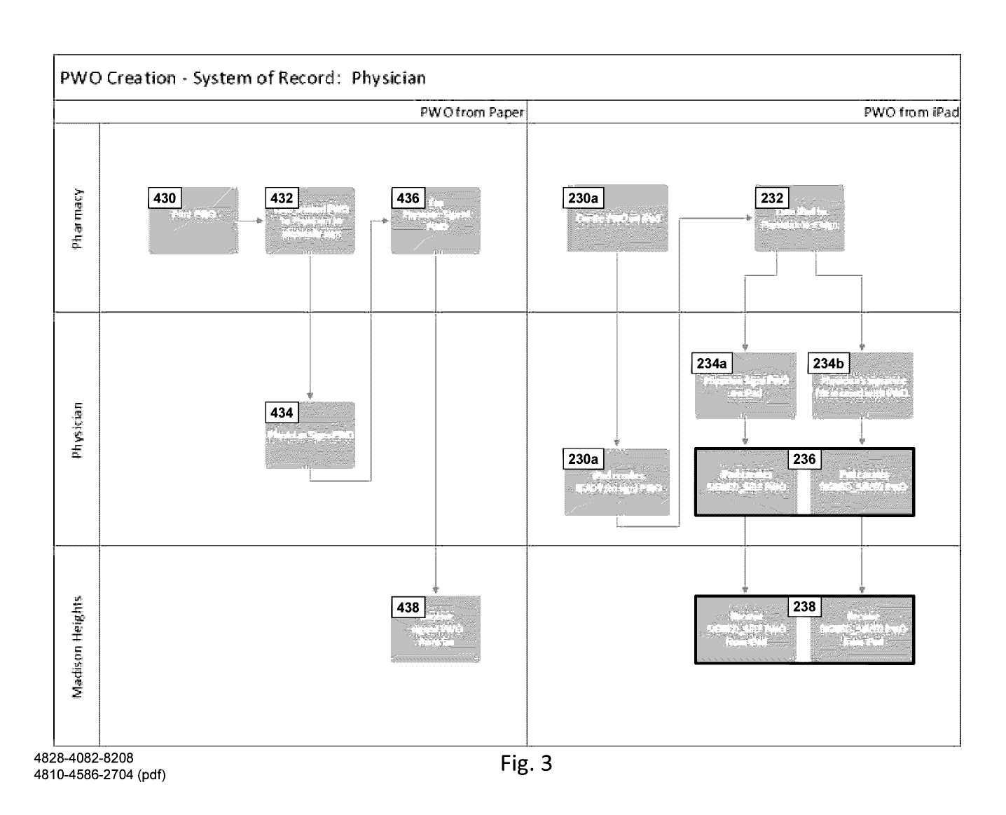

Referring to FIG. 3, existing methods of submitting Signed PWO's to third party equipment providers includes printing 430 a Draft PWO by an entity, such as a pharmacy filling an order for a prescription that requires the use of medical equipment; requesting 432 a physician to sign the Draft PWO; signing the Draft PWO by the physician, thereby creating 434 a Signed PWO; transmitting 436, such as by mail, hand deliver, fax, and/or otherwise, the Signed PWO; and receiving 438, by a third party such as a hospital or other provider of medical equipment, the Signed PWO. The systems and methods of the present invention streamline this process.

Still referring to FIG. 3, various methods of the present invention include creating 230a, 230b a Draft PWO and requesting 232 a physician to sign the Draft PWO. In some embodiments, the Draft PWO is an electronic PWO that is created by an entity, such as a pharmacy, by inputting 230a information into an electronic device, such as an electronic tablet or other electronic device now known or later developed. In some such embodiments, the electronic device creates 230b the Draft PWO based in whole or in part on the inputted information. In other embodiments, the Draft PWO is created 230b automatically based on information provided by a physician. For instance, in some such embodiments, the system of the present invention automatically creates a Draft PWO in response to one or more action, such as creation and/or signing of a prescription for medicine that reasonably requires use of medical equipment for which a PWO is reasonably required.

Still referring to FIG. 3, some methods of the present invention further include creating 234a, 234b a Signed PWO and transmitting 236 the Signed PWO. In some such embodiments, a physician utilizes a user interface to sign 234a the Draft PWO, thereby creating a Signed PWO. In other such embodiments, the physician approves 234b the Draft PWO, such as by authorizing use of a saved signature to be used with the Draft PWO, thereby creating a Signed PWO. In still other embodiments, the method further includes transmitting 236, such as by email or otherwise, the Signed PWO and receiving 238, by a third party such as a hospital or other provider of medical equipment, the Signed PWO.

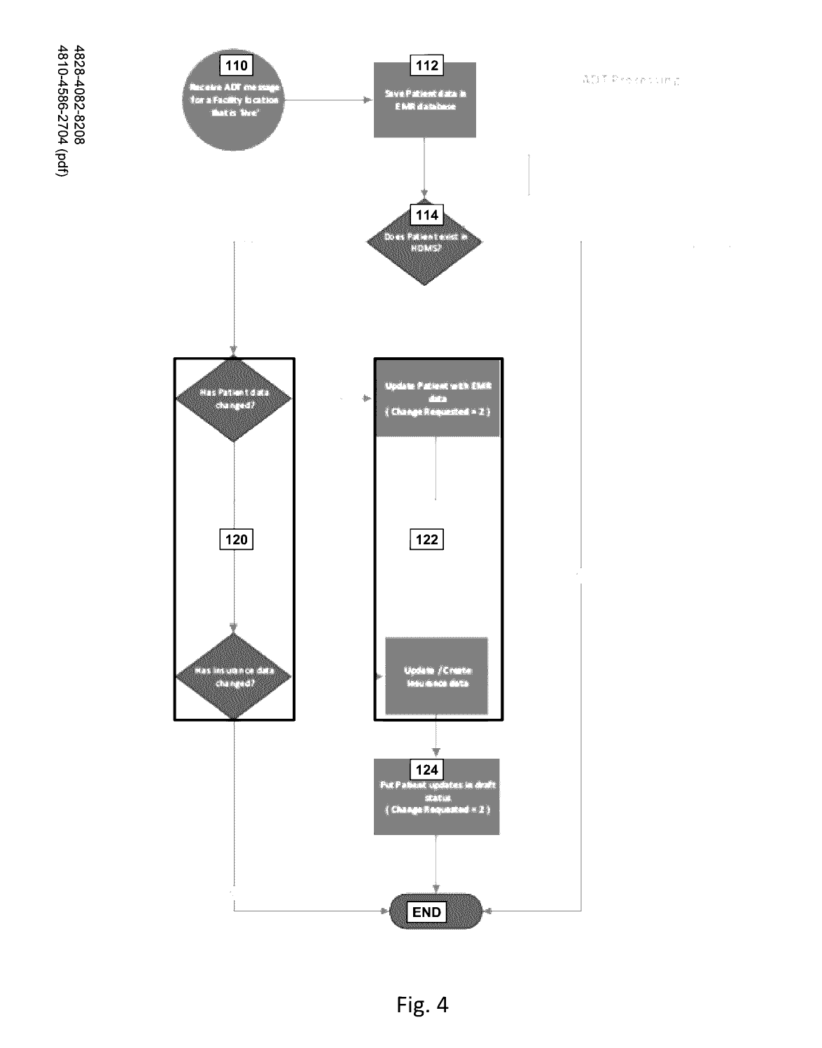

Referring to FIG. 4, various systems and methods of the present invention include processing ADT information. In some embodiments, such methods include obtaining 110 ADT information associated with a patient, such as all or part of an ADT Message 102, and saving 112 all or some of the obtained information in a database 50 of the data collection system 10. In other embodiments, such methods includes checking 114 the database 50 for a Patient Record 52 associated with the patient. In some methods where a corresponding Patient Record 52 does not exist, a Patient Record 52 is created. In other methods where a corresponding Patient Record 52 does exist, the present invention further includes comparing 120 information in the Patient Record 52 with the obtained ADT information. In some such methods, the information includes patient data and/or patient insurance data. In some methods where information in the Patient Record 52 does not match the corresponding obtained ADT information, the Patient Record 52 is updated 122 with information from the ADT Message 102. In some such methods, the Patient Record 52 is marked 124 as a draft and/or is otherwise categorized and/or marked for review prior to acceptance of the updated information.

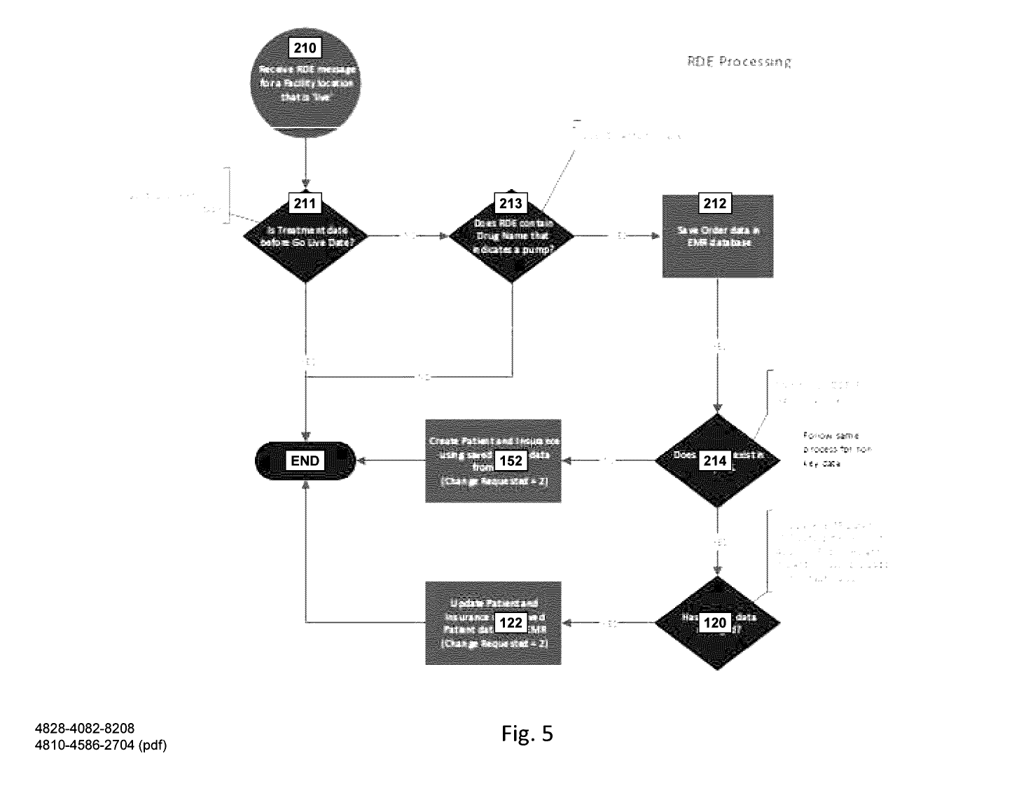

Referring to FIG. 5, various methods of the present invention include obtaining 210 RDE information 200 associated with a patient, such as part or all of an RDE Message 202. Some methods further include assessing 211 the RDE information. For instance, in some such embodiments, a treatment date is assessed 211 so as to determine whether the treatment date is before a go live date for the system. In other embodiments, the method includes associating 213 the RDE information with one or more piece of medical equipment, such as a pump. In some such methods, at least some of the RDE information is saved 212 in a database 50.

Still referring to FIG. 5, some methods of the present invention include checking 214 the database 50 for a Patient Record 52 associated with the RDE information. In some methods where a corresponding Patient Record 52 does not exist, a Patient Record 52 is created 152. In other methods where a corresponding Patient Record 52 does exist, the present invention further includes comparing 120 information in the Patient Record 52 with the RDE information. In some methods where information in the Patient Record 52 does not match corresponding RDE information, the Patient Record 52 is updated 122 with the RDE information.

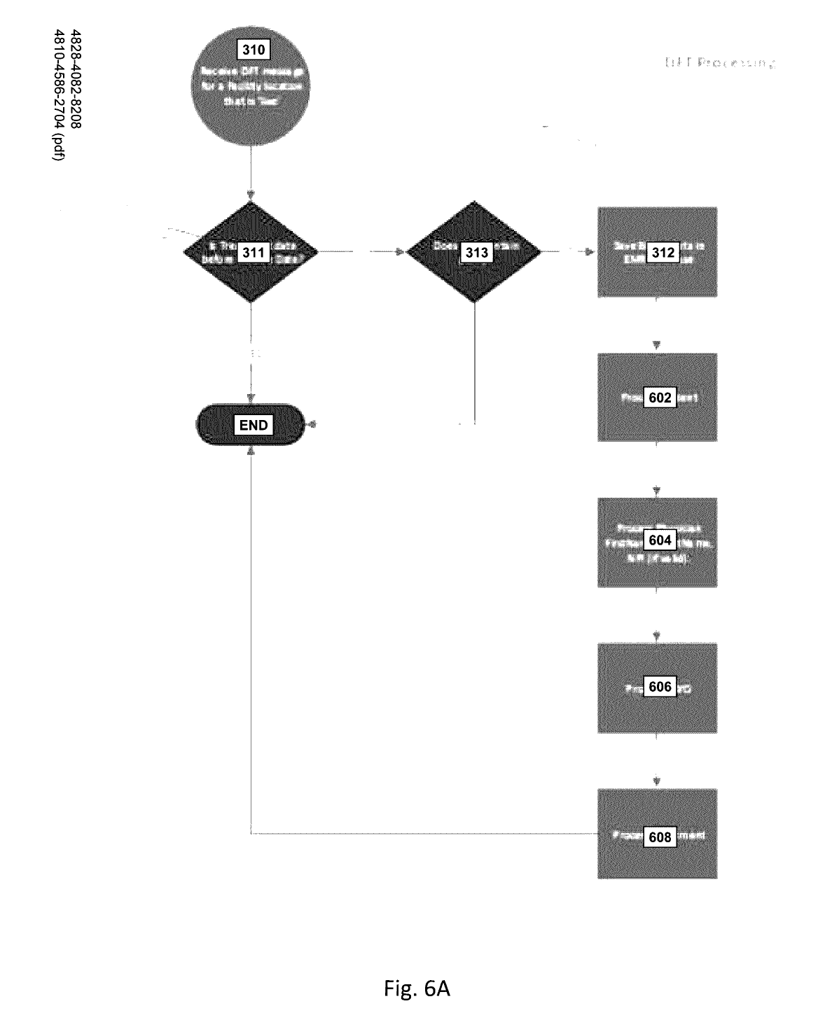

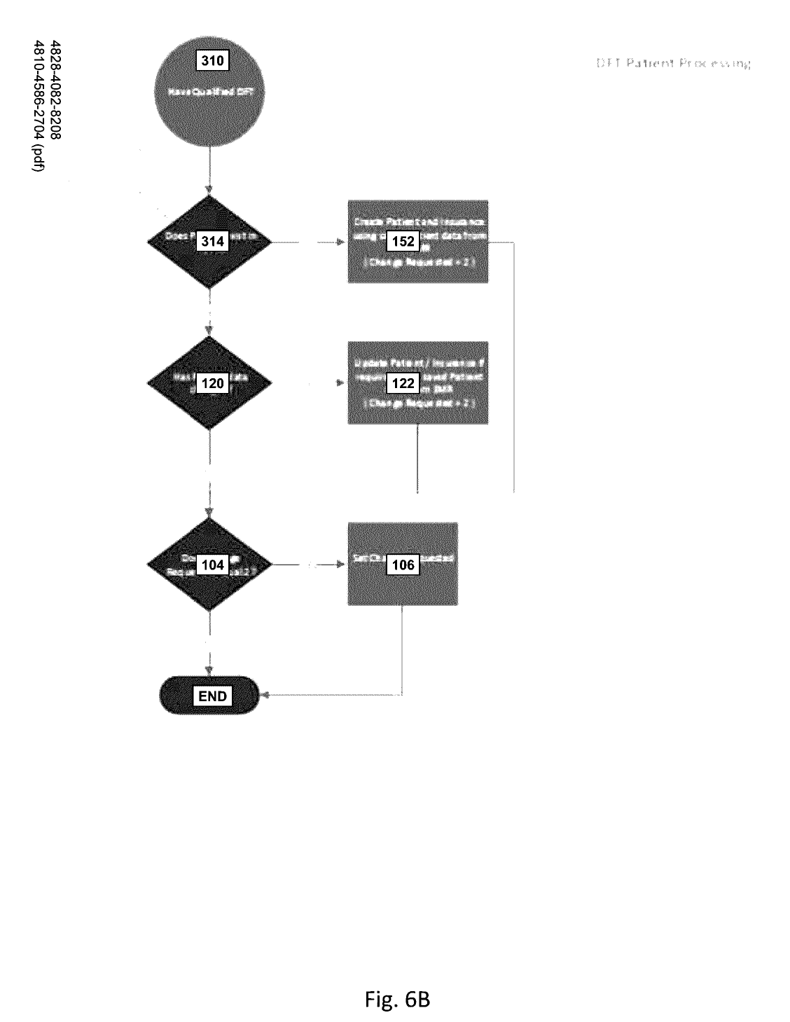

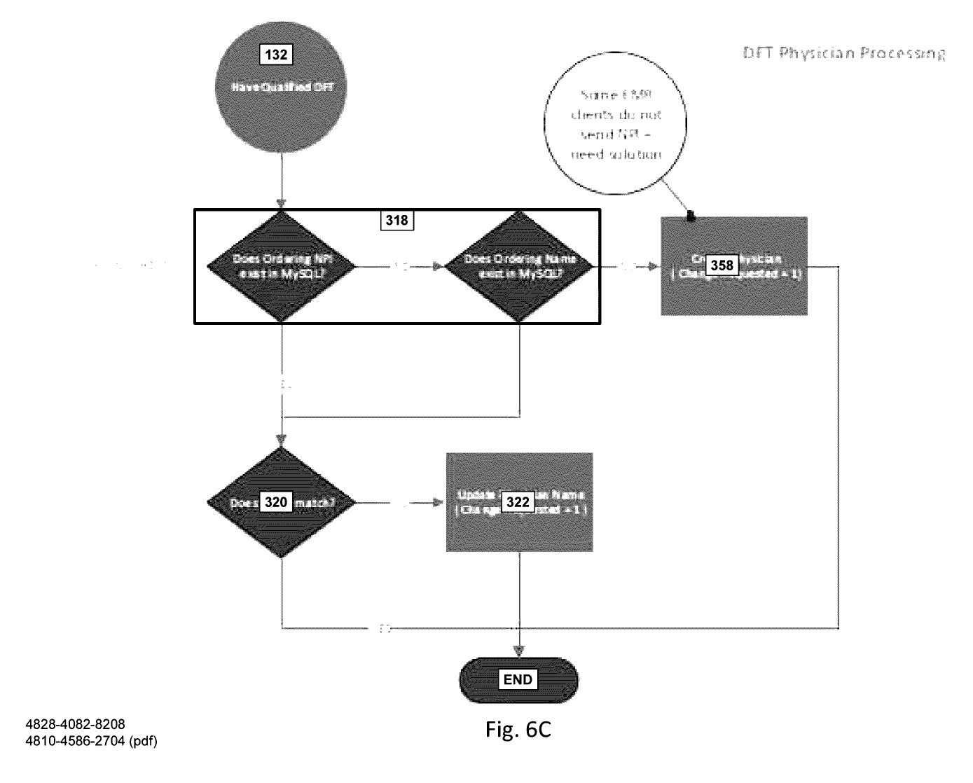

Referring to FIG. 6A, various methods of the present invention include obtaining 310 DFT information associated with a patient, such as part or all of a DFT Message 302. Some methods further include assessing 311 the DFT information. For instance, in some such embodiments, a treatment date is assessed 311 so as to determine whether the treatment date is before a go live date for the system. In other embodiments, the method includes associating 313 DFT information with one or more piece of medical equipment, such as a pump. In some such methods, at least some of the DFT information is saved 312 in a database 50. In some such embodiments, the method of the present invention further includes processing 602 patient information, processing 604 physician information, processing 606 PWO information, and/or processing 606 treatment information.

Referring to FIG. 6B, some methods of the present invention include obtaining 310 DFT information 300, such as part or all of a DFT Message 302. Other methods include checking 314 the database 50 for a Patient Record 52 associated with the DFT information. In some methods where a corresponding Patient Record 52 does not exist, a Patient Record 52 is created 152. In other methods where a corresponding Patient Record 52 does exist, the present invention further includes comparing 120 information in the Patient Record 52 with the DFT information. In some methods where information in the Patient Record 52 does not match corresponding DFT information, the Patient Record 52 is updated 122 with the DFT information.

Still referring to FIG. 6B, some embodiments of the present invention include determining 104 whether a change has been requested for the Patient Record 52. In some such embodiments, the change request is indicated by a marker and/or a designation, such as a numeral 2 in a change request category. In other such embodiments, such as after a change to the Patient Record 52 has been made, the marker and/or designation associated with a change request is set 106 to a marker and/or designation that does not indicate a change is requested, such as a numeral 1 in a change request category.

Referring to FIG. 6C, some methods of the present invention include obtaining 310 DFT information 300, such as part or all of a DFT Message 302. Other methods include checking 318 a database 50 for a Physician Record 58 associated with the DFT information. For instance, in some methods, the DFT information is a code associated with a physician, such as a National Provider Identifier (“NPI”). In other methods, the DFT information is the name of the physician. In some embodiments where a corresponding Physician Record 58 does not exist, a Physician Record 58 is created 358. In other methods where a corresponding Physician Record 58 does exist, the present invention further includes comparing 320 information in the Physician Record 58, such as the physician's name and/or other information, with the obtained DFT information. In some methods where information in the Physician Record 58 does not match corresponding DFT information, the Physician Record 58 is updated 322 with the DFT information.

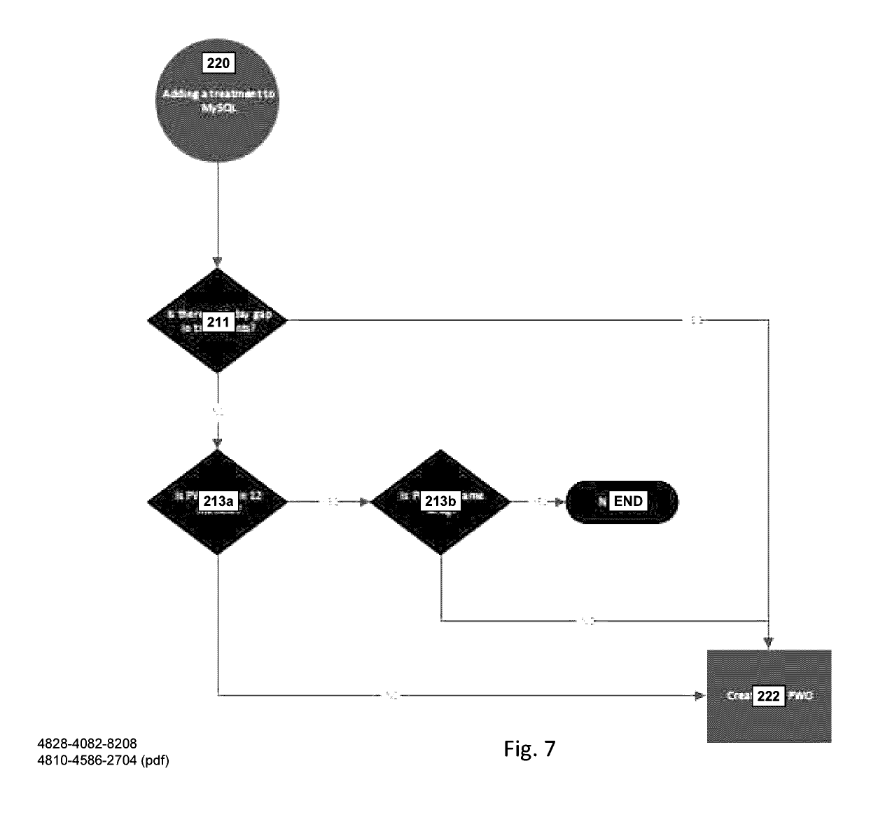

Referring to FIG. 7, some methods of the present invention include creating 220 a treatment, such as by creating or editing a Treatment Record 53 and/or updating a Patient Record 52 to add one or more treatment. In some embodiments, the method includes assessing 211 the treatment, the Treatment Record 53, and/or the Patient Record 52, so as to determine whether there is a gap in treatment, such as a 60 day gap in treatment, that requires creating 222 a new PWO. In other embodiments, the method includes assessing 213 a PWO associated with the patient so as to determine whether the PWO can be associated with the treatment. In some such embodiments, the method includes assessing 213a whether the age of the PWO is within an acceptable age, such as twelve months. In other such embodiments, the method includes assessing 213b whether the PWO is for the same drug as called out for in the treatment. In some embodiments, such as when there is a gap in treatment, the age of the PWO is not within an acceptable age, and/or the PWO is for a different drug, a new PWO is created 222.

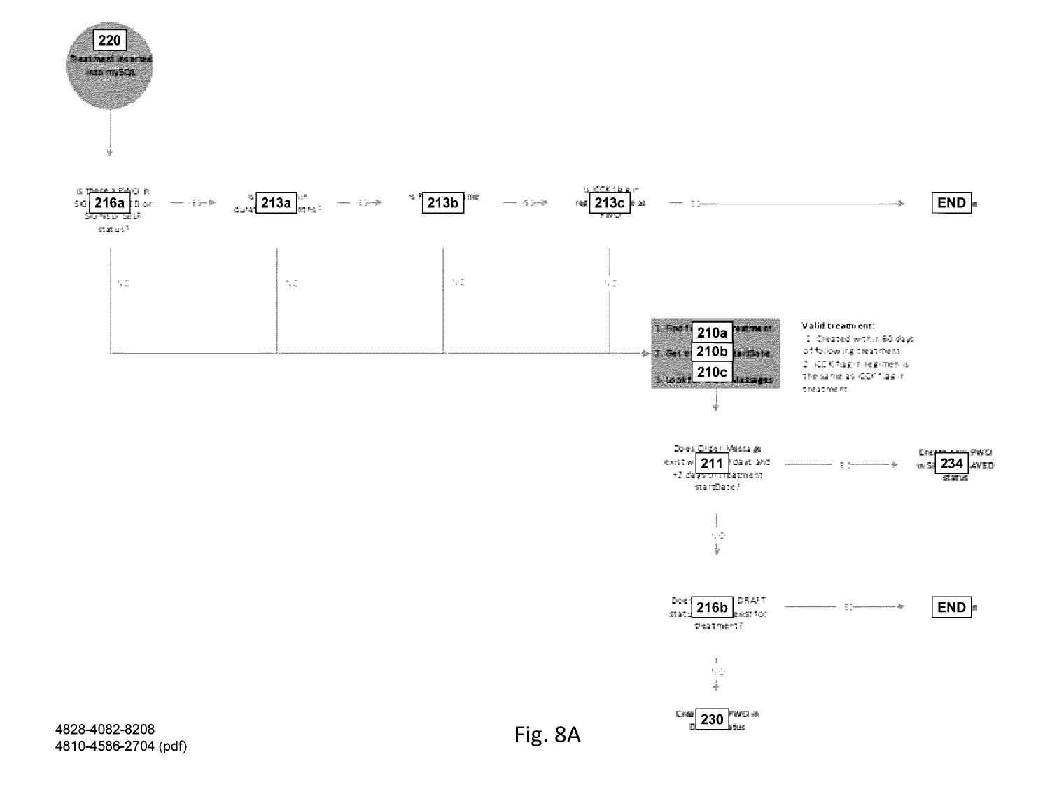

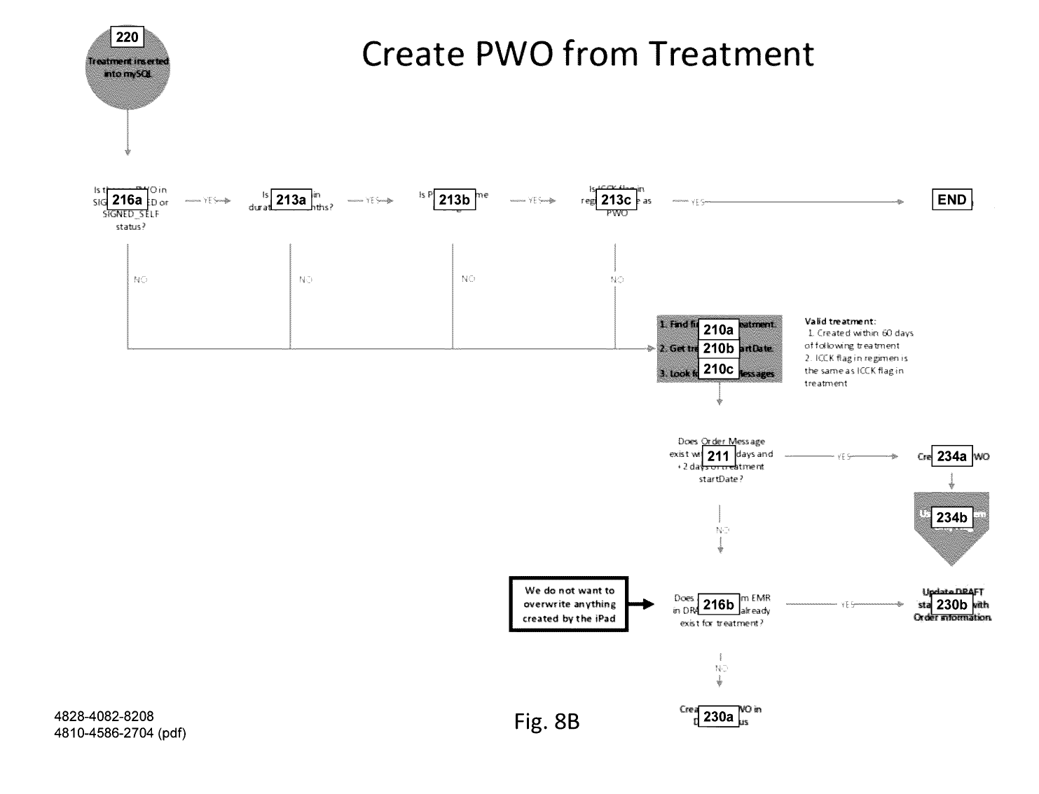

Referring to FIG. 8A, some methods of the present invention include creating 220 a treatment. In some embodiments, the method includes checking 216a for a Signed PWO. In other embodiments, the method includes assessing a PWO associated with the patient so as to determine whether the PWO can be associated with the treatment. In some such embodiments, the method includes assessing 213a whether the age of the PWO is within an acceptable age, such as twelve months. In other such embodiments, the method includes assessing 213b whether the PWO is for the same drug as called out for in the treatment. In still other such embodiments, the method includes assessing 213c whether a flag associated with the treatment, such as an Intravenous Catheter Care Kit flag (an “ICCK” flag) associated with the treatment is the same as a flag of the PWO.

In some embodiments, such as when there is no Signed PWO, the age of the PWO is not within an acceptable age, the PWO is for a different drug and/or the ICCK flags are different, additional steps are taken. For instance, in some such embodiments, a first valid treatment is obtained 210a, a start date for the treatment is obtained 210b, and/or other RDE information 200, such as the date of an RDE Message 202, is obtained 210c. In some such embodiments, the method includes assessing 211 whether a Signed PWO can be created 234. In some embodiments, a Signed PWO is created 234 if a date of an RDE Message is within 60 days of the creation date of the Signed PWO and/or the date of the RDE Message is within 2 days of a treatment start date. In other embodiments, the method includes checking 216b for a Draft PWO. In some such embodiments, a Draft PWO is created 230 if a date of an RDE Message is within 60 days of the creation date of Signed PWO, and/or the date of the RDE Message is within 2 days of a treatment start date.

Referring to FIG. 8B, some methods of the present invention include creating 220 a treatment. In some embodiments, the method includes checking 216a for a Signed PWO. In other embodiments, the method includes assessing a PWO associated with the patient so as to determine whether the PWO can be associated with the treatment. In some such embodiments, the method includes assessing 213a whether the age of the PWO is within an acceptable age, such as twelve months. In other such embodiments, the method includes assessing 213b whether the PWO is for the same drug as called out for in the treatment. In still other such embodiments, the method includes assessing 213c whether an ICCK flag associated with the treatment is the same as an ICCK flag of the PWO.

In some embodiments, such as when there is no Signed PWO, the age of the PWO is not within an acceptable age, the PWO is for a different drug and/or the ICCK flags are different, additional steps are taken. For instance, in some such embodiments, a first valid treatment is obtained 210a, a start date for the treatment is obtained 210b, and/or other RDE information 200, such as the date of an RDE Message 202, is obtained 210c. In some such embodiments, the method includes assessing 211c whether a PWO can be created 234a. In some embodiments, a PWO is created 234a if a date of an RDE Message is beyond 60 days of the creation date of the PWO and/or the date of the RDE Message is within 2 days of a treatment start date. In some such embodiments, the PWO includes and/or is associated with 234b a proprietary designation, such as a “UsesInfuSystem Only Flag”. In other embodiments, the method includes checking 216b for a Draft PWO. In some such embodiments where an existing Draft PWO does not exist, a Draft PWO is created 230a. In other such embodiments where an existing Draft PWO does exist, the Draft PWO is updated 230b. In some embodiments where an existing Draft PWO is updated 230b, some or all of the information, such as information created by a mobile device such as a tablet, is not overwritten.

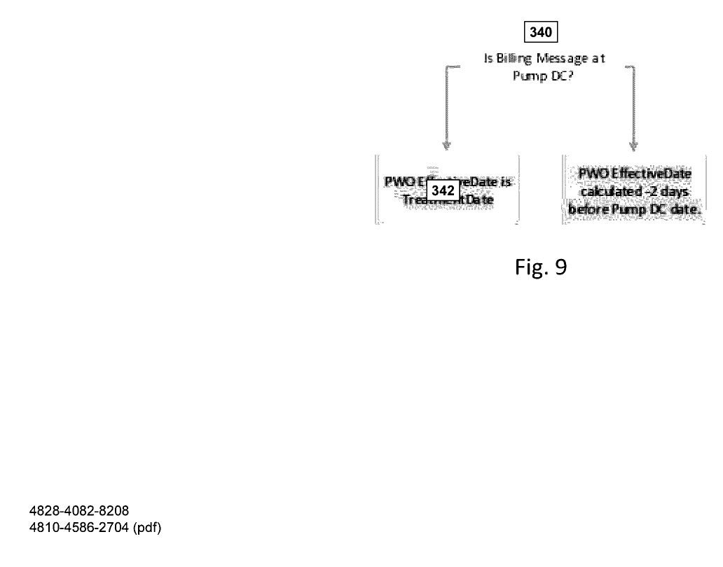

Referring to FIG. 9, some embodiments of the present invention include establishing 340 a PWO Effective Date. In some embodiments, the method includes assessing 341 whether a DFT Message 302, such as a Billing Message, is associated with a piece of equipment, such as a pump and/or a pump discharge (a “Pump DC”). In some such embodiments, the DFT Message 302 includes a Treatment Date and/or a Pump DC date. In some embodiments, the method includes recognizing 342 the PWO Effective Date so as to be equal to the Treatment Date if the DFT Message is not associated with a Pump DC.

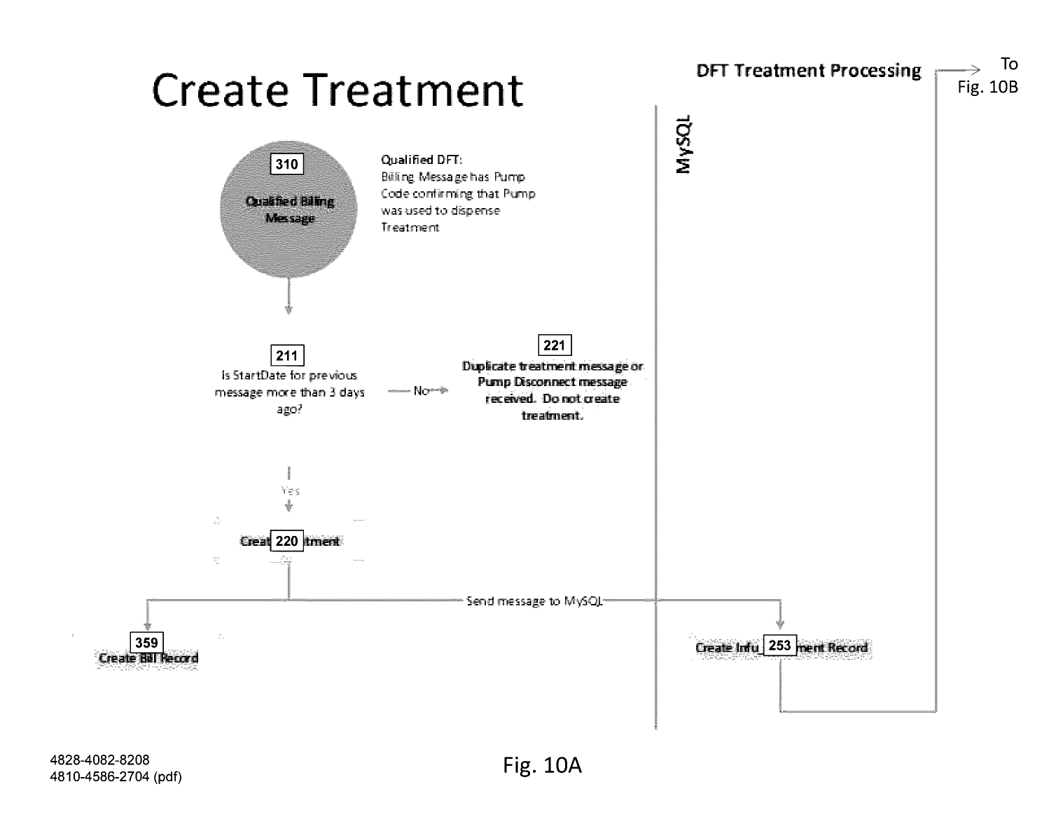

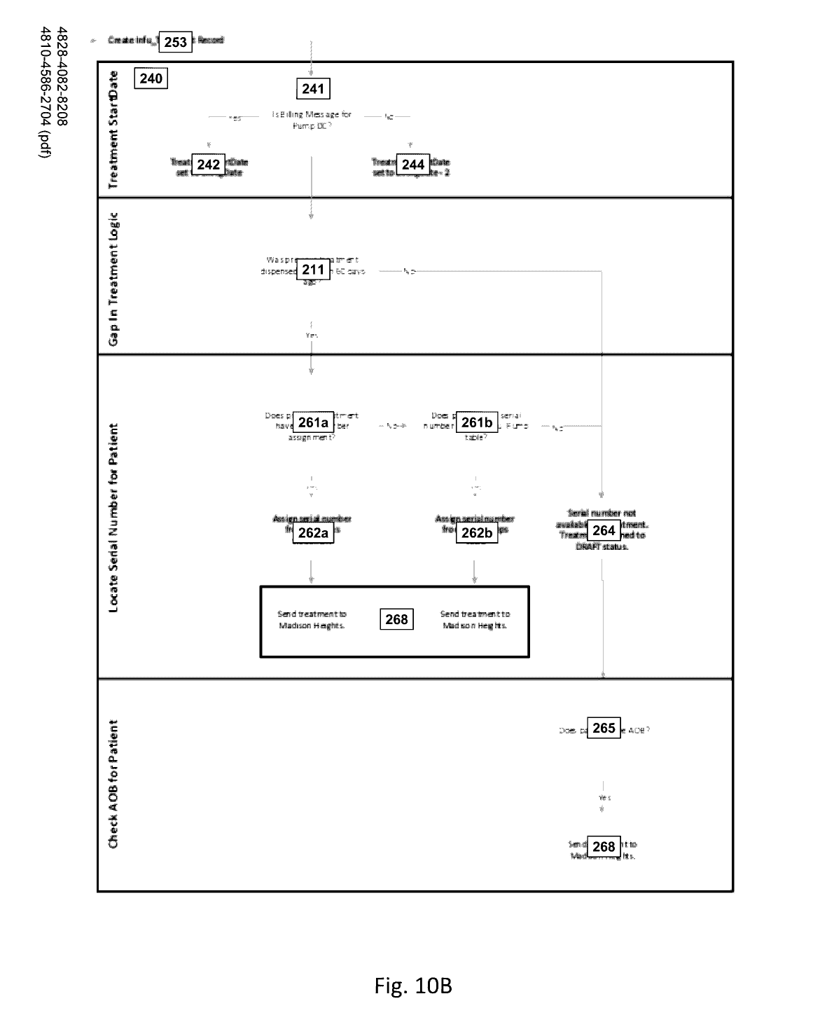

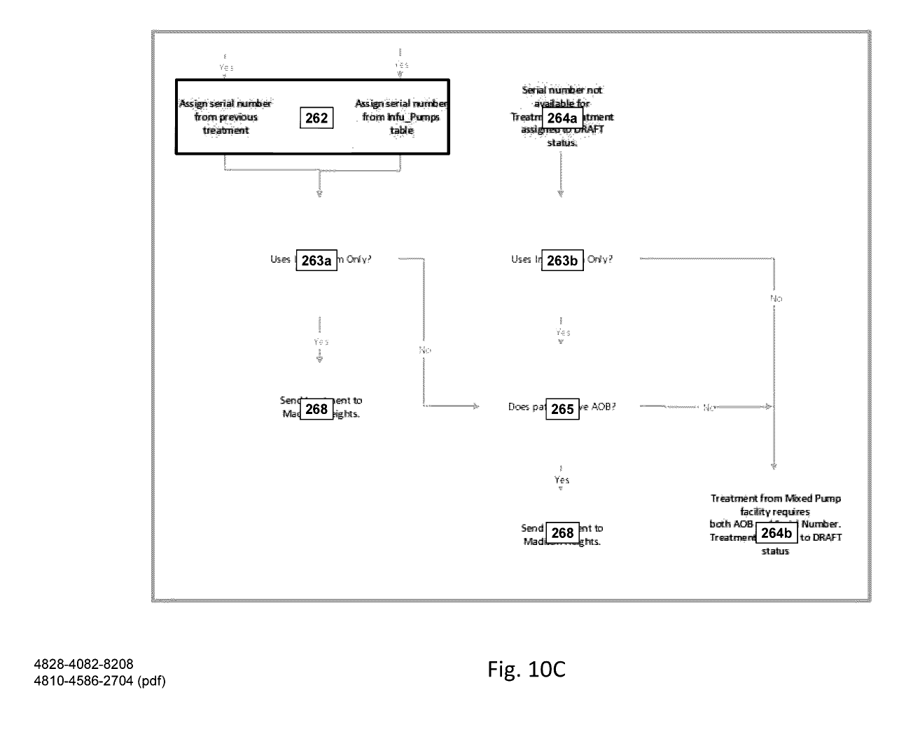

Referring to FIG. 10A, some embodiments of the present invention include methods of processing DFT information 300. In some embodiments, the method includes obtaining 310 DFT information 300, such as a DFT Message 302. In some such embodiments, the DFT Message 302 is a Qualified Billing Message confirming that a piece of equipment, such as a pump, was used to dispense a treatment. In other embodiments, the method further includes assessing 211 whether a start date from a previous associated message, such as a treatment message, is more than three days before the current date. In some embodiments, a treatment is not created 221 if a start date for a previous message is three days or less from the current date. In other embodiments, a treatment is created 220 if the start date from the previous message is more than 3 day prior to the current date. In some such embodiments, a Bill Record 59 is created 359. In some embodiments, the method further includes creating 253 a Treatment Record 53 associated with a treatment for a patient.

Referring to FIG. 10B, some methods of creating 253 a Treatment Record 53 include establishing 240 a Treatment Start Date. In some embodiments, the method includes assessing 241 whether a DFT Message 302, such as a Billing Message, is associated with a piece of equipment, such as a pump and/or a Pump DC. In some such embodiments, the DFT Message 302 includes a Billing Date. In some embodiments, the method includes setting 242 the Treatment Start Date so as to be equal to the Billing Date if the DFT Message is associated with a Pump DC. In other embodiments, the method includes setting 244 the Treatment Start Date so as to be two days before the Billing Date if the DFT Message is not associated with a Pump DC.

Still Referring to FIG. 10B, some methods of creating 253 a Treatment Record 53 include assessing 211 one or more prior treatment, such as by assessing one or more Treatment Record 53 and/or Patient Record 52, so as to determine whether there is an excessive gap in treatment, such as a 60 day gap in treatment. In some embodiments where any gap in treatment is not excessive, such as less than 60 days, the method further includes determining 261a whether the previous treatment is associated with a particular piece of equipment, such as by associating the previous treatment with a specific Serial Number. In some such embodiments where the previous treatment is associated with a particular piece of equipment, the identification of the piece of equipment is assigned 262a to the patient. In other embodiments where any gap in treatment is not excessive, including embodiments where the previous treatment is not associated with a particular piece of equipment, the method further includes determining 261b whether the patient is associated with a particular piece of equipment, such as by a Serial Number of the equipment being listed in a table such that the table links the Serial Number with the patient. In some such embodiments where the patient is associated with a particular piece of equipment, the identification of the piece of equipment is assigned 262b to the patient.

Still Referring to FIG. 10B, in some embodiments where a gap in treatment is excessive, such as 60 days or more, athe present invention further includes assigning 264 the treatment to a Draft status and/or otherwise designating the treatment as not being ready to complete. In some such embodiments, the method further includes assessing 265 whether the patient has an assignment of benefit. In some such embodiments where the patient has an assignment of benefit, the method further includes sending 268 a PWO for the treatment to a third party, such as a hospital or other provider of medical equipment.

Still Referring to FIG. 10B, some methods, such as where a gap in treatment is not excessive and the patient is not associated with a particular piece of equipment, further include assigning 264b the treatment to a Draft status and/or otherwise designating the treatment as not being ready to complete. In some such embodiments, the method further includes assessing 265 whether the patient has an assignment of benefit. In some such embodiments where the patient has an assignment of benefit, the method further includes sending 268 a PWO for the treatment to a third party, such as a hospital or other provider of medical equipment.

Referring to FIG. 10C, some embodiments of the present invention include assigning 262 to a patient an identification of a piece of equipment, such as a Serial Number of the piece of equipment. In some such embodiments, the piece of equipment is associated with the patient prior to assigning the piece of equipment to the patient, such as by way of a previous treatment of the patient being associated with the piece of equipment and/or the identification of the piece of equipment being listed in a table such that the table links the piece of equipment with the patient. In other such embodiments, the method further includes assessing 263a whether the patient and/or a facility utilizes the system of the present invention as an exclusive means of processing PWO's. In some such embodiments where the use of the system of the present invention is the exclusive means of processing PWO's, the method further includes sending 268 a PWO for the treatment to a third party, such as a hospital or other provider of medical equipment. In other such embodiments where the use of the system of the present invention is not the exclusive means of processing PWO's, the method further includes assessing 265 whether the patient has an assignment of benefit. In some such embodiments where the patient has an assignment of benefit, the method further includes sending 268 a PWO for the treatment to a third party, such as a hospital or other provider of medical equipment. In other such embodiments where the patient does not have an assignment of benefit, the method further includes assigning 264b the treatment to a Draft status and/or otherwise designating the treatment as not being ready to complete.

Still Referring to FIG. 10C, some embodiments of the present invention include assigning 264a the treatment to a Draft status and/or otherwise designating the treatment as not being ready to complete. In some such embodiments, the method further includes assessing 263b whether the patient and/or a facility utilizes the system of the present invention as an exclusive means of processing PWO' s. In some embodiments where the use of the system of the present invention is not the exclusive means of processing PWO's, the method further includes assigning 264b the treatment to a Draft status and/or otherwise designating the treatment as not being ready to complete. In other embodiments where the use of the system of the present invention is the exclusive means of processing PWO's, the method further includes assessing 265 whether the patient has an assignment of benefit. In some such embodiments where the patient has an assignment of benefit, the method further includes sending 268 a PWO for the treatment to a third party, such as a hospital or other provider of medical equipment. In other such embodiments where the patient does not have an assignment of benefit, the method further includes assigning 264b the treatment to a Draft status and/or otherwise designating the treatment as not being ready to complete.

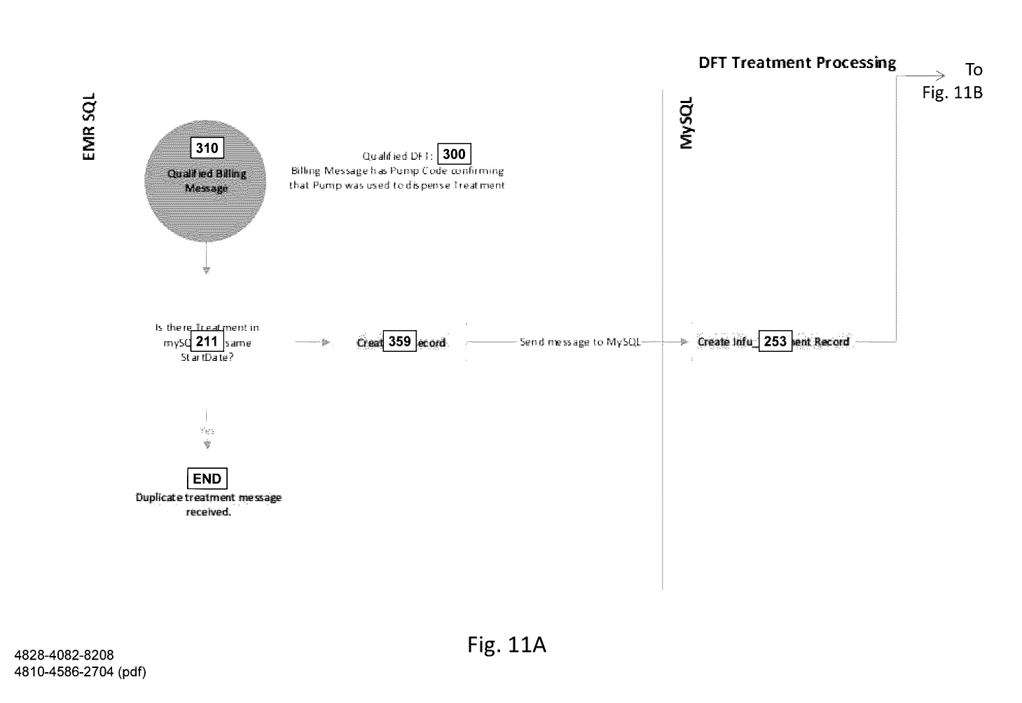

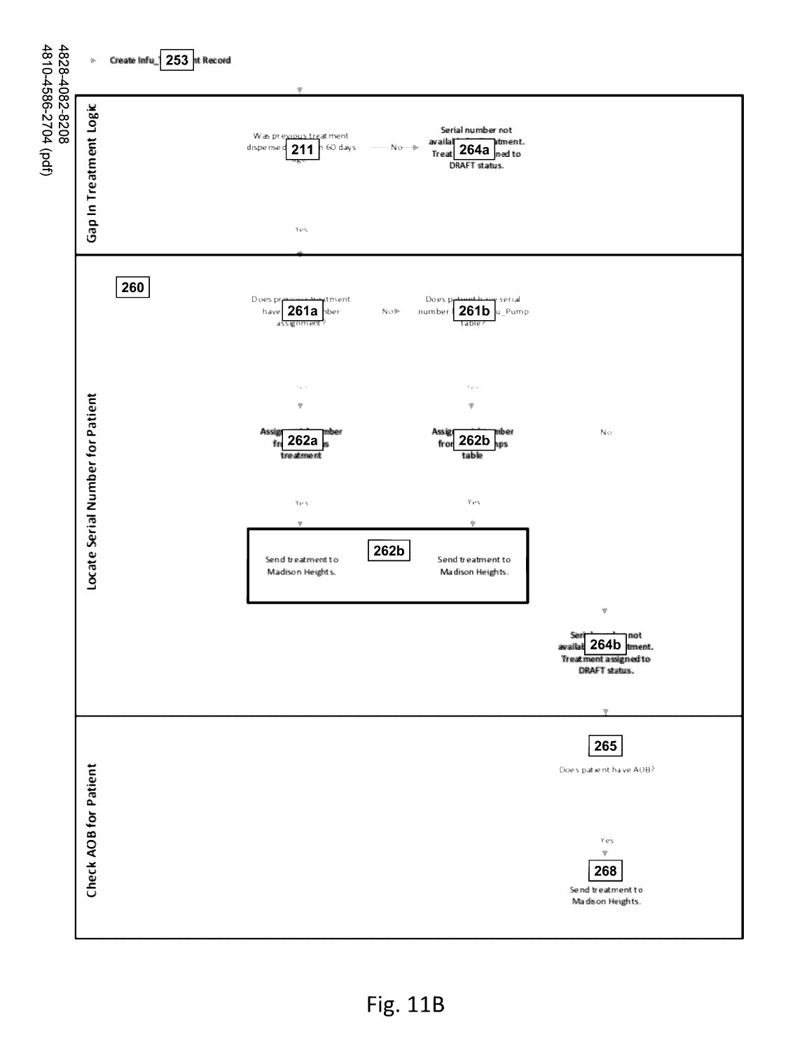

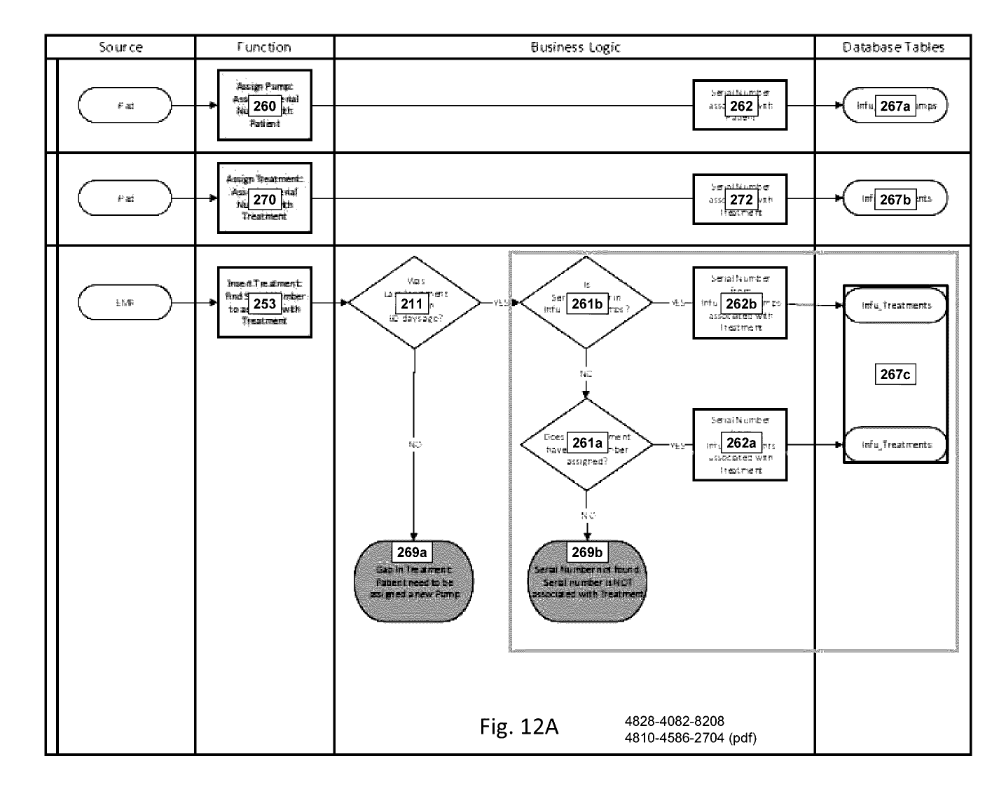

Referring to FIG. 11A, some embodiments of the present invention include methods of processing DFT information 300. In some embodiments, the method includes obtaining 310 DFT information 300, such as a DFT Message 302. In some such embodiments, the DFT Message 302 is a Qualified Billing Message confirming that a piece of equipment, such as a pump, was used to dispense a treatment. In other such embodiments, the DFT information 300 includes a Start Date, such as a Start Date for a treatment.

Still referring to FIG. 11A, some methods of the present invention include assessing 211 whether a Start Date associated with the DFT information is the same as a Start Date associated with a treatment for a patient, such as a Start Date associated with a Patient Record 52 and/or a Treatment Record 53. In some such embodiments where the Start Dates are not the same, a bill record 59 is created 359. In some such embodiments, the method further includes creating 253 a Treatment Record 53 associated with a treatment for a patient.

Referring to FIG. 11B, some methods of creating 253 a Treatment Record 53 include assessing 211 one or more prior treatment, such as by assessing one or more Treatment Record 53 and/or Patient Record 52, so as to determine whether there is an excessive gap in treatment, such as a 60 day gap in treatment. In some embodiments where a gap in treatment is excessive, such as 60 days or more, the method of the present invention further includes assigning 264a the treatment to a Draft status and/or otherwise designating the treatment as not being ready to complete. In other embodiments where any gap in treatment is not excessive, such as less than 60 days, the method further includes determining 261a whether the previous treatment is associated with a particular piece of equipment, such as by associating the previous treatment with a specific Serial Number. In some such embodiments where the previous treatment is associated with a particular piece of equipment, the identification of the piece of equipment is assigned 262a to the patient. In other embodiments where any gap in treatment is not excessive, including embodiments where the previous treatment is not associated with a particular piece of equipment, the method further includes determining 261b whether the patient is associated with a particular piece of equipment, such as by a Serial Number of the equipment being listed in a table such that the table links the Serial Number with the patient. In some such embodiments where the patient is associated with a particular piece of equipment, the identification of the piece of equipment is assigned 262b to the patient. In some embodiments, after associating a piece of equipment with a treatment and/or a patient, a PWO for the treatment is sent 268 to a third party, such as a hospital or other provider of medical equipment.

Still Referring to FIG. 11B, some methods, such as where a gap in treatment is not excessive and the patient is not associated with a particular piece of equipment, further include assigning 264b the treatment to a Draft status and/or otherwise designating the treatment as not being ready to complete. In some such embodiments, the method further includes assessing 265 whether the patient has an assignment of benefit. In some such embodiments where the patient has an assignment of benefit, the method further includes sending 268 a PWO for the treatment to a third party, such as a hospital or other provider of medical equipment.

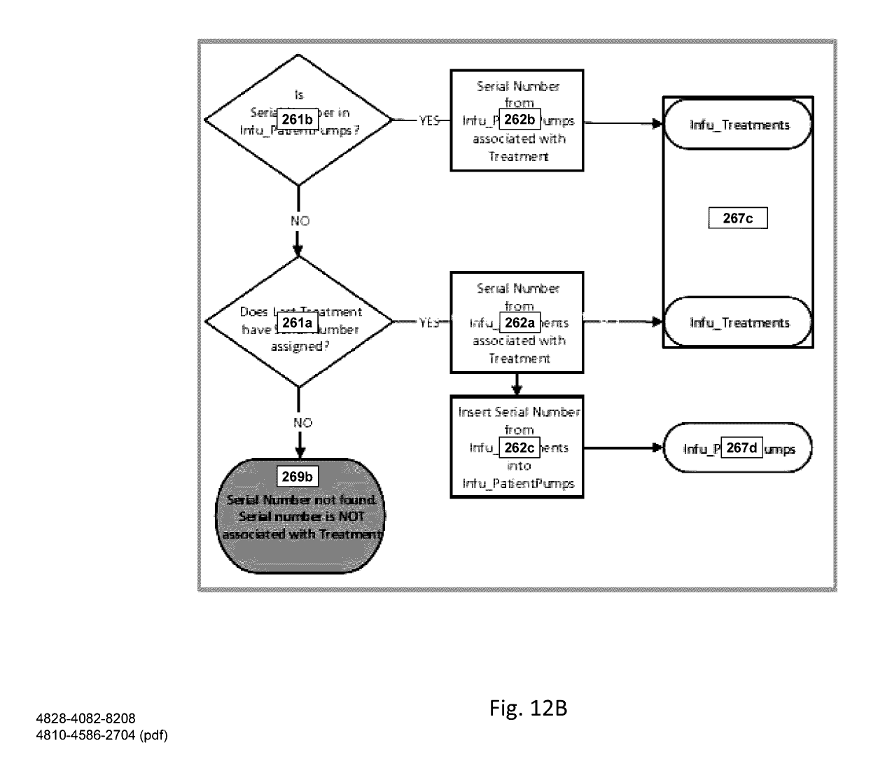

Referring to FIG. 12A, some embodiments of the present invention include assigning 260 a pump to a patient, such as by assigning 262 an identification of the pump, such as a Serial Number of the pump, to the patient. In some such embodiments, the method further includes saving 267a the association in a table of a database 50, such as an equipment table and/or a patients table. In other embodiments, the method includes assigning 270 a treatment to a patient such as by assigning 272 an identification of the treatment, such as a Serial Number of the treatment, to the patient. In some such embodiments, the method further includes saving 267b the association in a table of a database 50, such as a treatments table and/or a patients table.

Still referring to FIG. 12A, some methods of the present invention include creating a treatment, such as by creating 253 a treatment record 53. In some embodiments, some methods of creating a treatment include assessing 211 one or more prior treatment, such as by assessing one or more Treatment Record 53 and/or Patient Record 52, so as to determine whether there is an excessive gap in treatment, such as a 60 day gap in treatment. In some embodiments where a gap in treatment is excessive, such as 60 days or more, the method of the present invention further includes associating 269a the patient with a piece of equipment.

Referring to FIGS. 12A and 12B, in some embodiments where any gap in treatment is not excessive, such as less than 60 days, the method includes determining 261b whether the patient is associated with a particular piece of equipment, such as by a Serial Number of the equipment being listed in a table such that the table links the Serial Number with the patient. In some such embodiments where the patient is associated with a particular piece of equipment, the identification of the piece of equipment is assigned 262b to the patient. In other embodiments where any gap in treatment is not excessive, including embodiments where the patient is not previously associated with a particular piece of equipment, the method includes determining 261a whether the previous treatment is associated with a particular piece of equipment, such as by associating the previous treatment with a specific Serial Number. In some such embodiments where the previous treatment is associated with a particular piece of equipment, the identification of the piece of equipment is assigned 262a to the patient. In some embodiments, after associating a piece of equipment with a treatment and/or a patient, the method further includes saving 267c the association in a table of a database 50, such as a treatments table and/or a patients table.

Still Referring to FIGS. 12A and 12B, some methods, such as where a gap in treatment is not excessive and the patient is not associated with a particular piece of equipment, the method of the present invention further includes associating 269b the patient with a piece of equipment.

Referring to FIG. 12B, some methods, such as where a gap in treatment is not excessive and the patient is associated with a particular piece of equipment, such as through a prior treatment, the method of the present invention further includes assigning 262c to the patient the identification of the piece of equipment. In some such embodiments, the method further includes saving 267d the association in a table of a database 50, such as an equipment table.

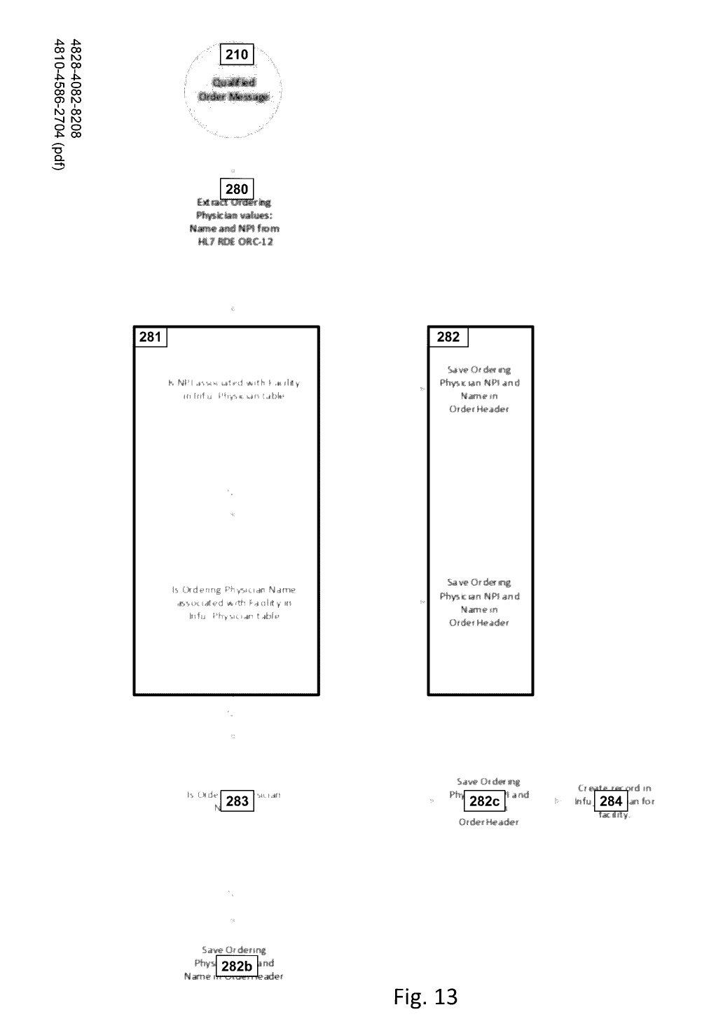

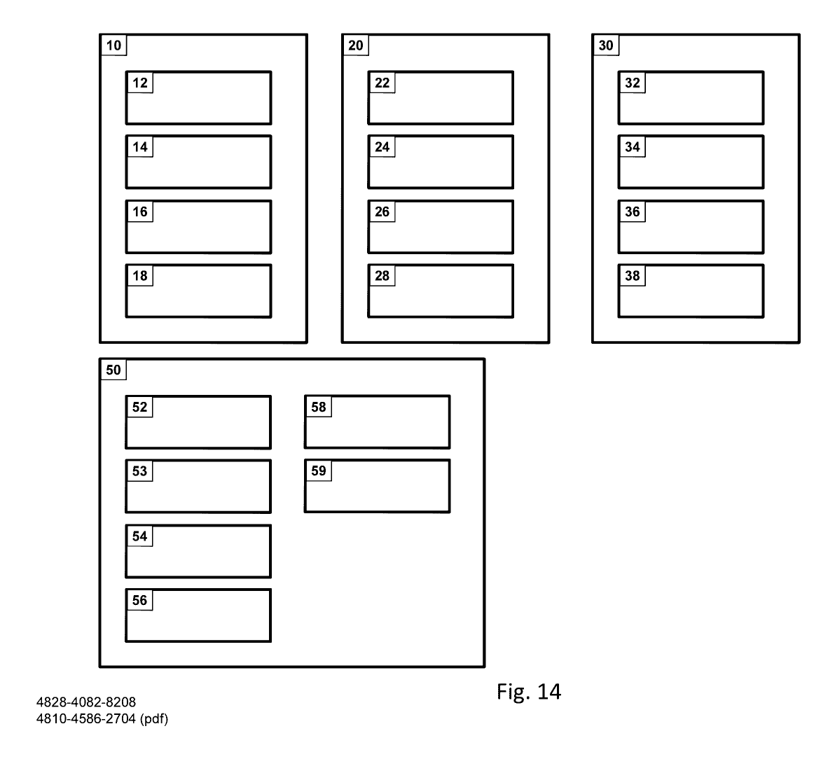

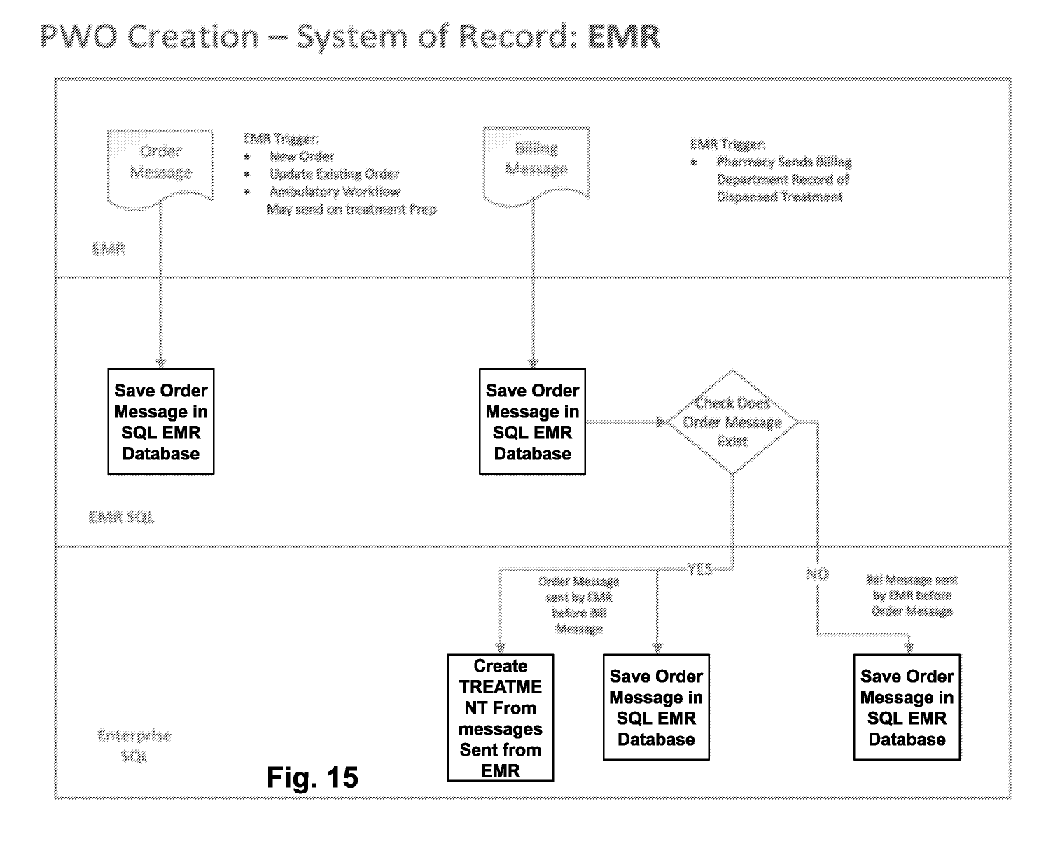

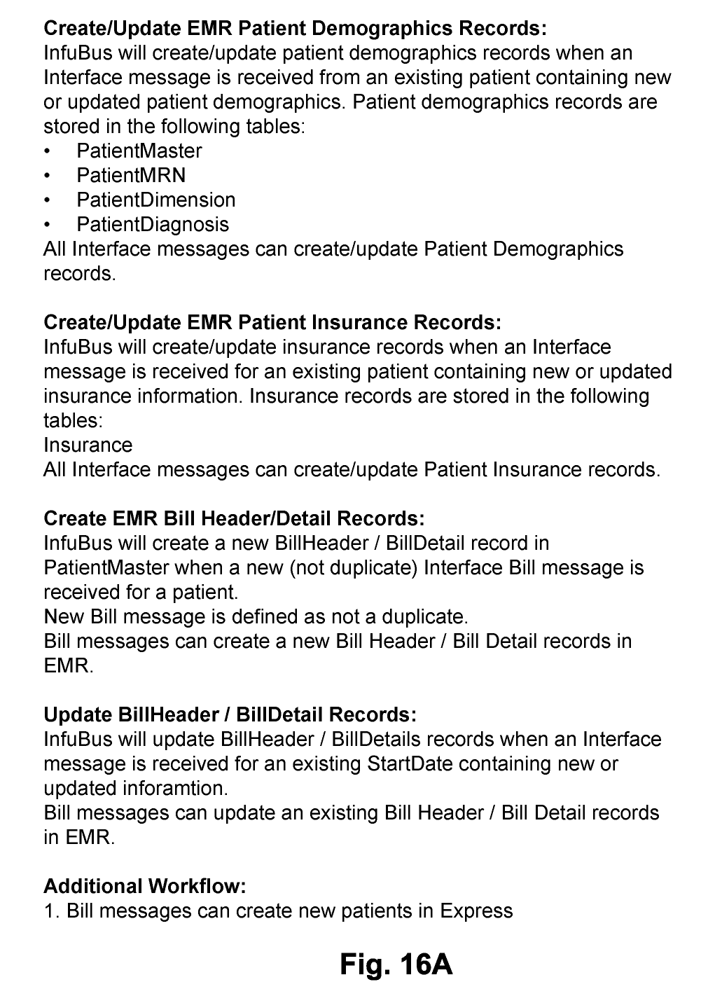

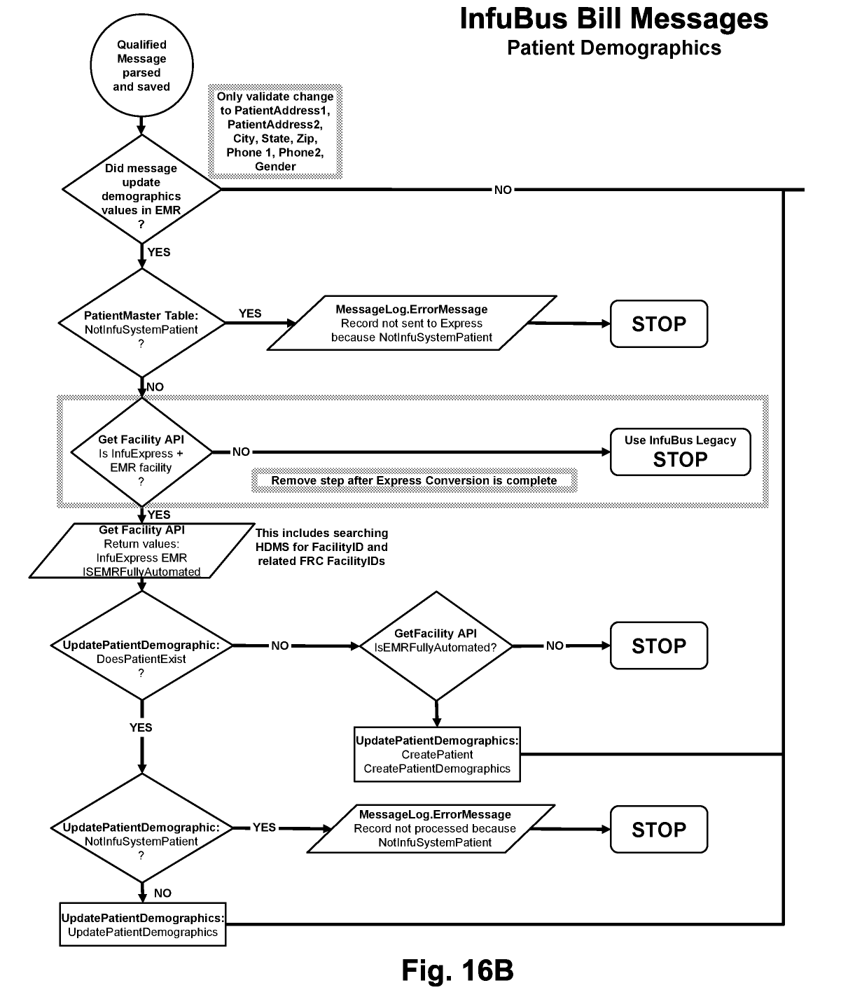

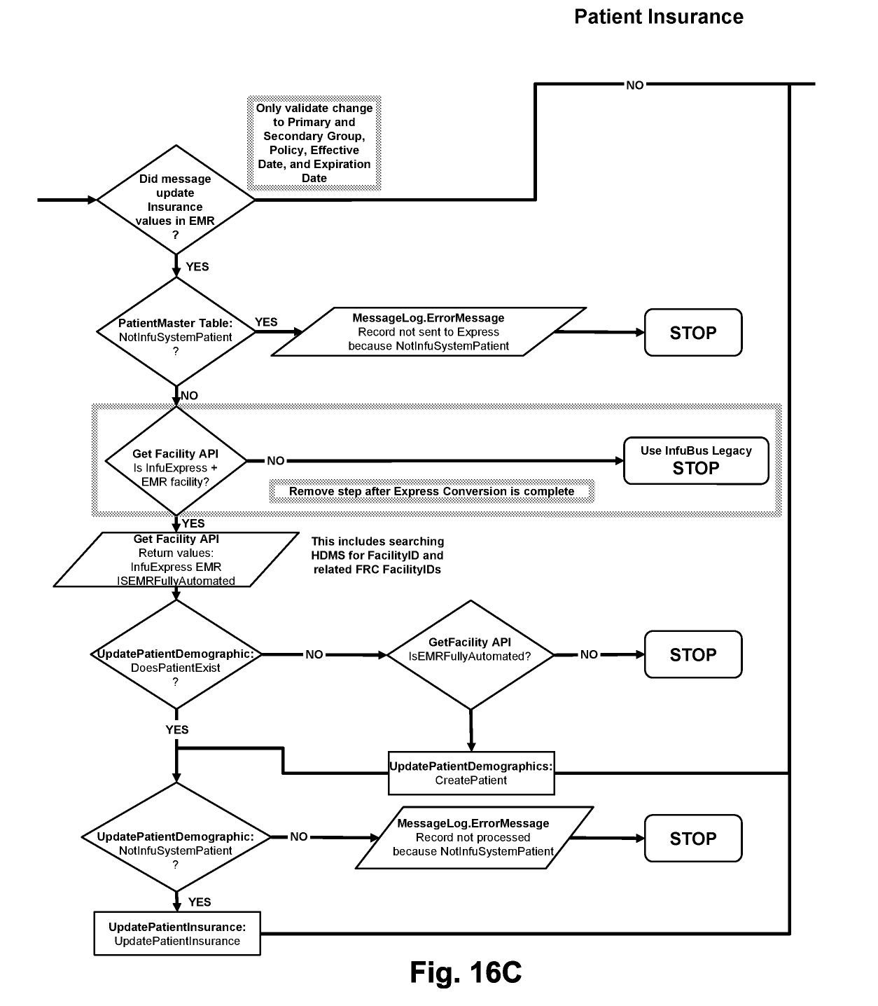

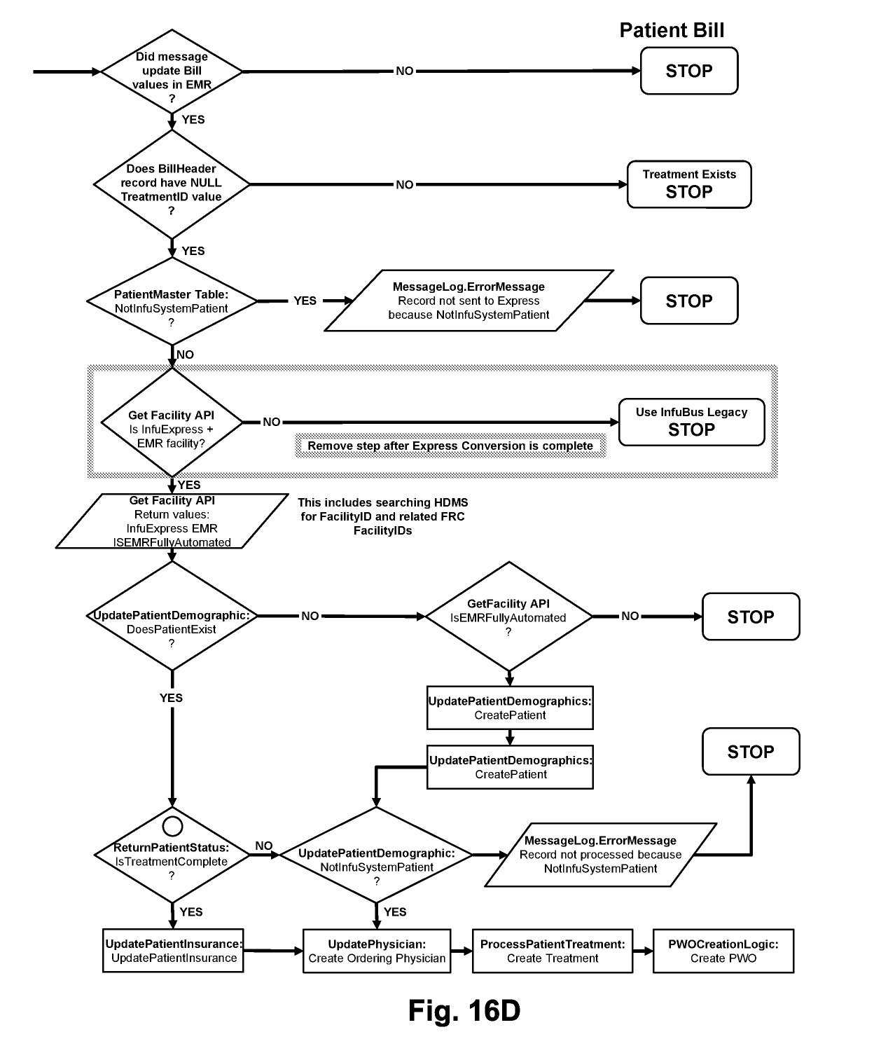

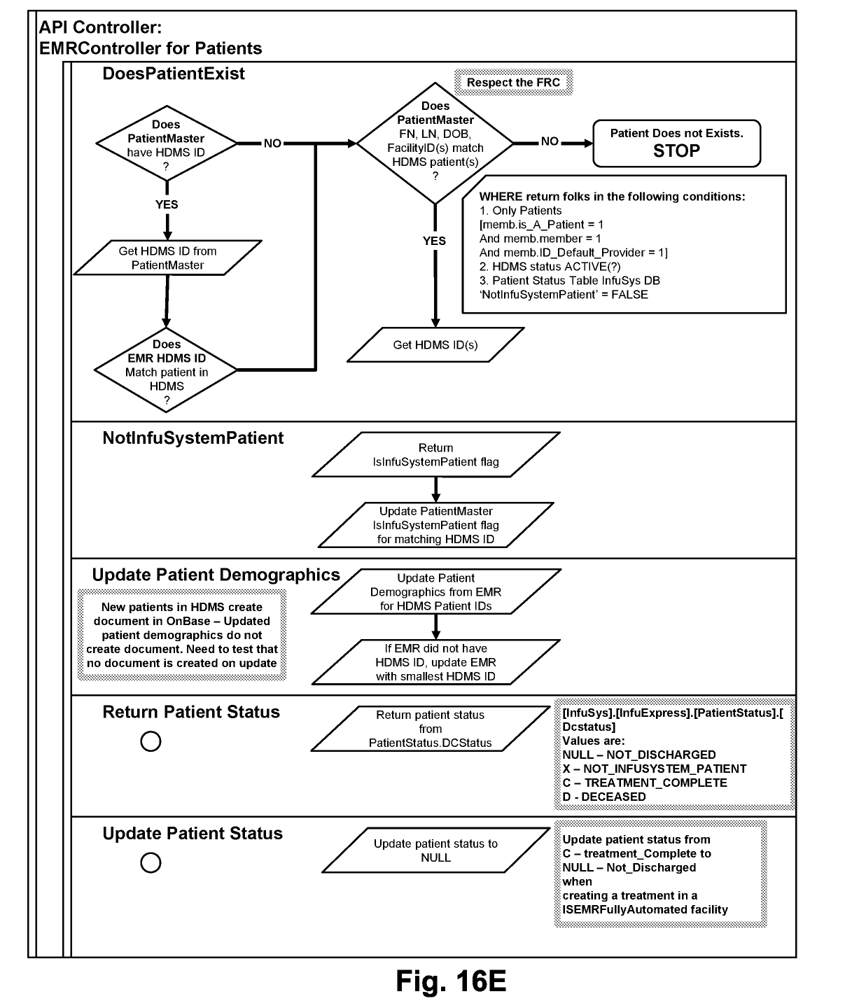

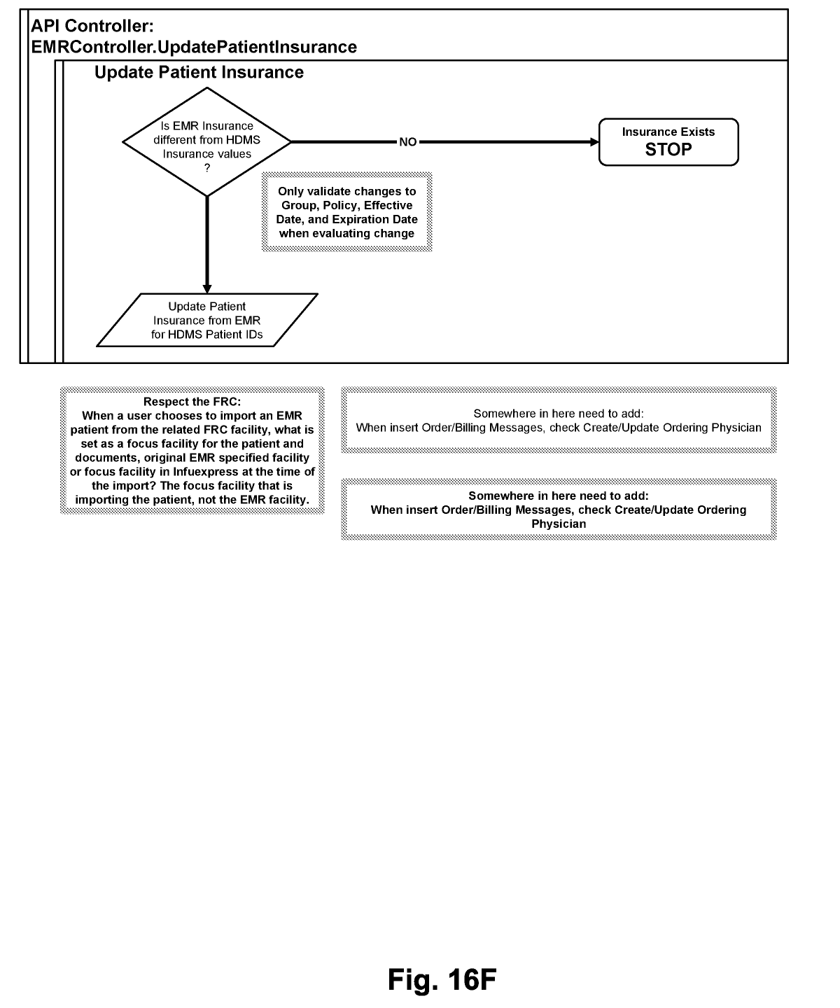

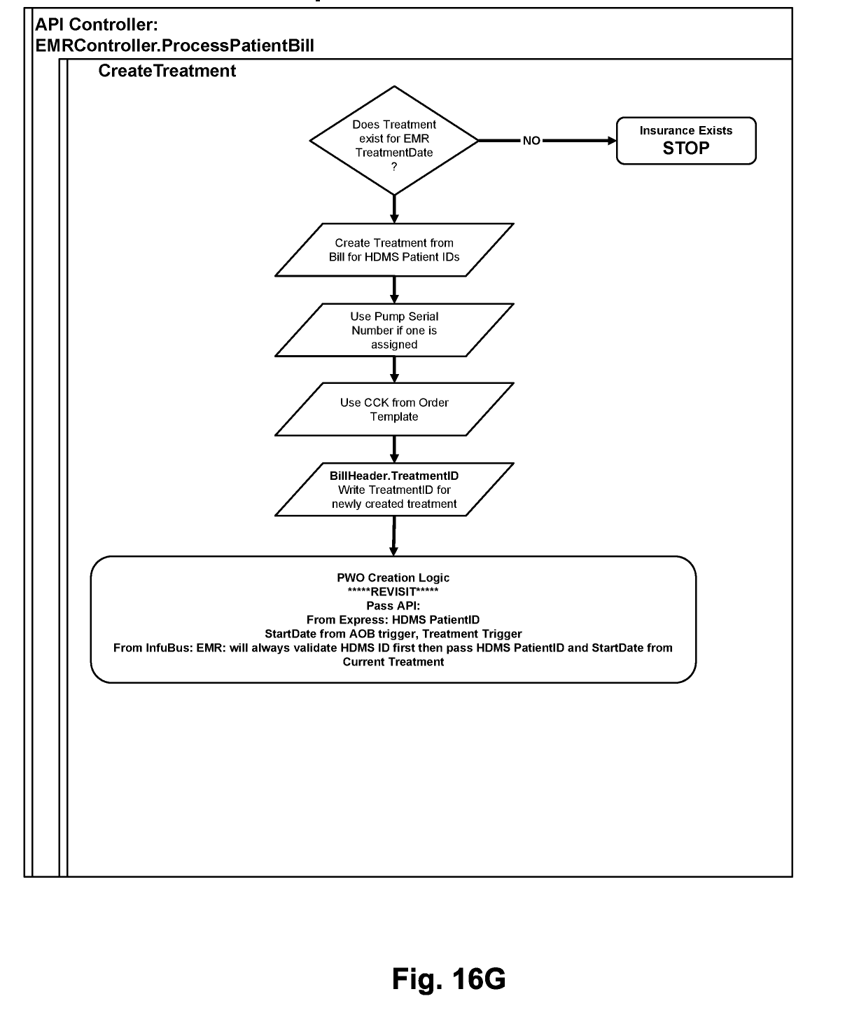

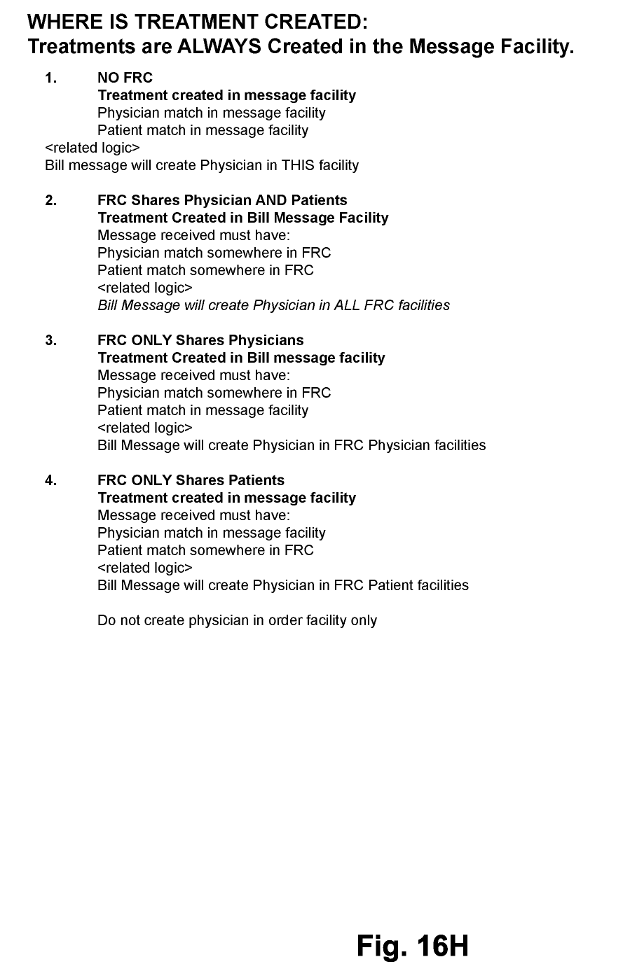

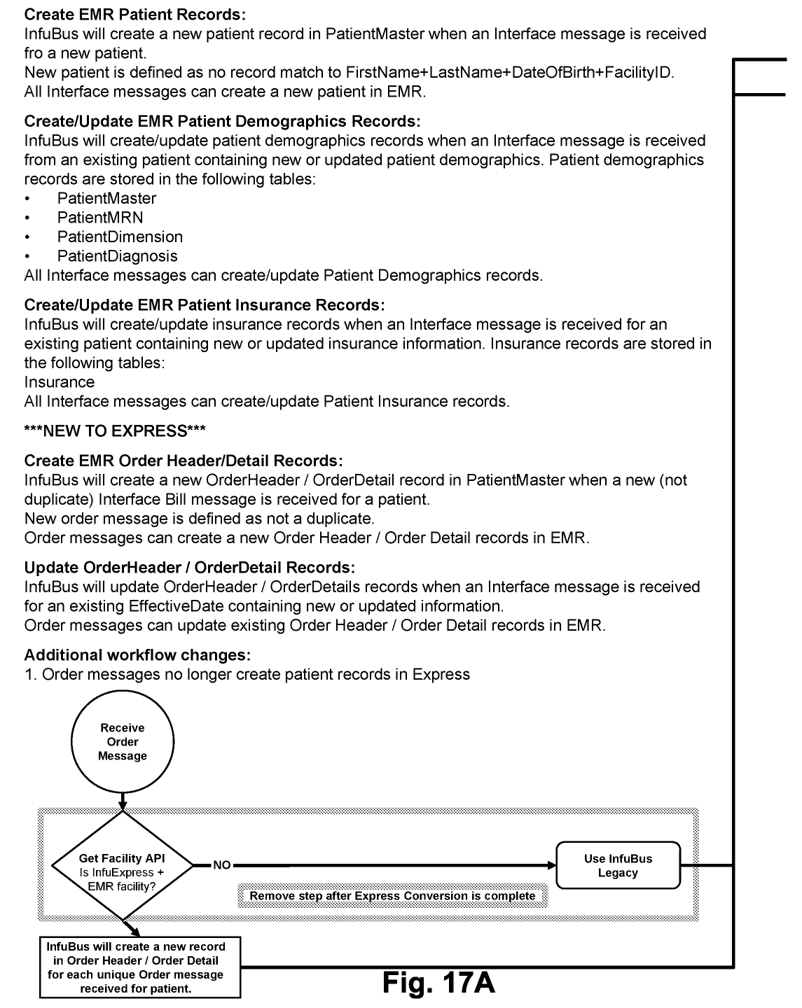

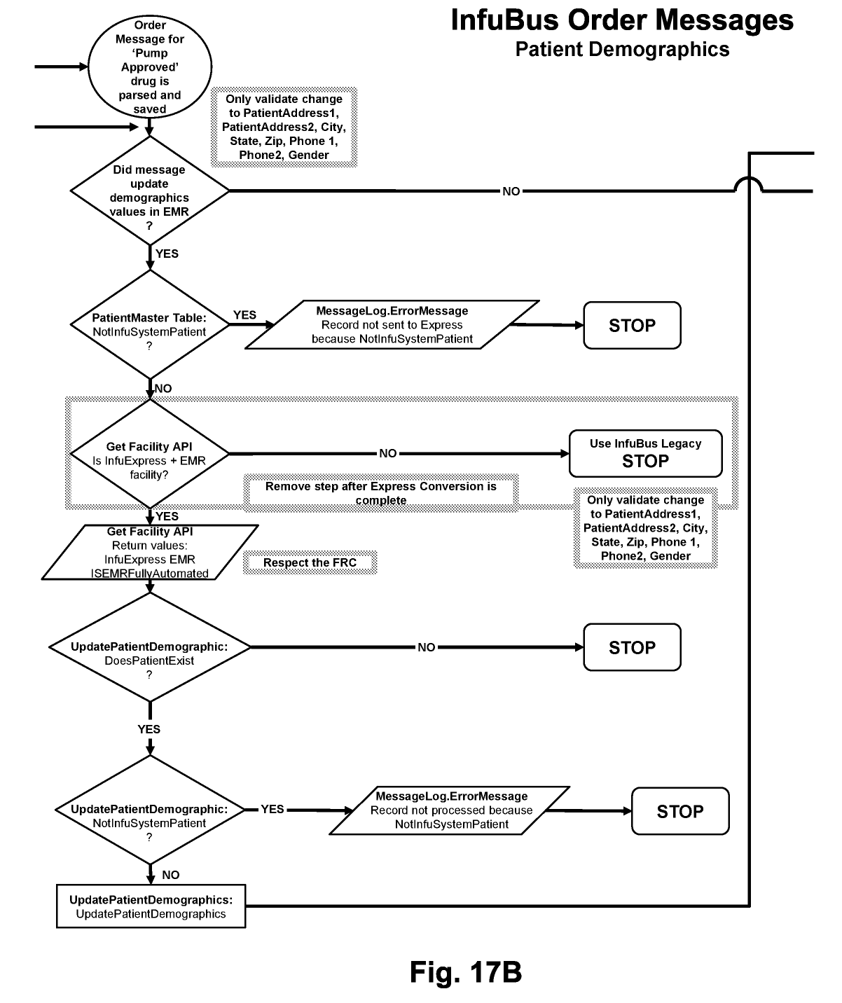

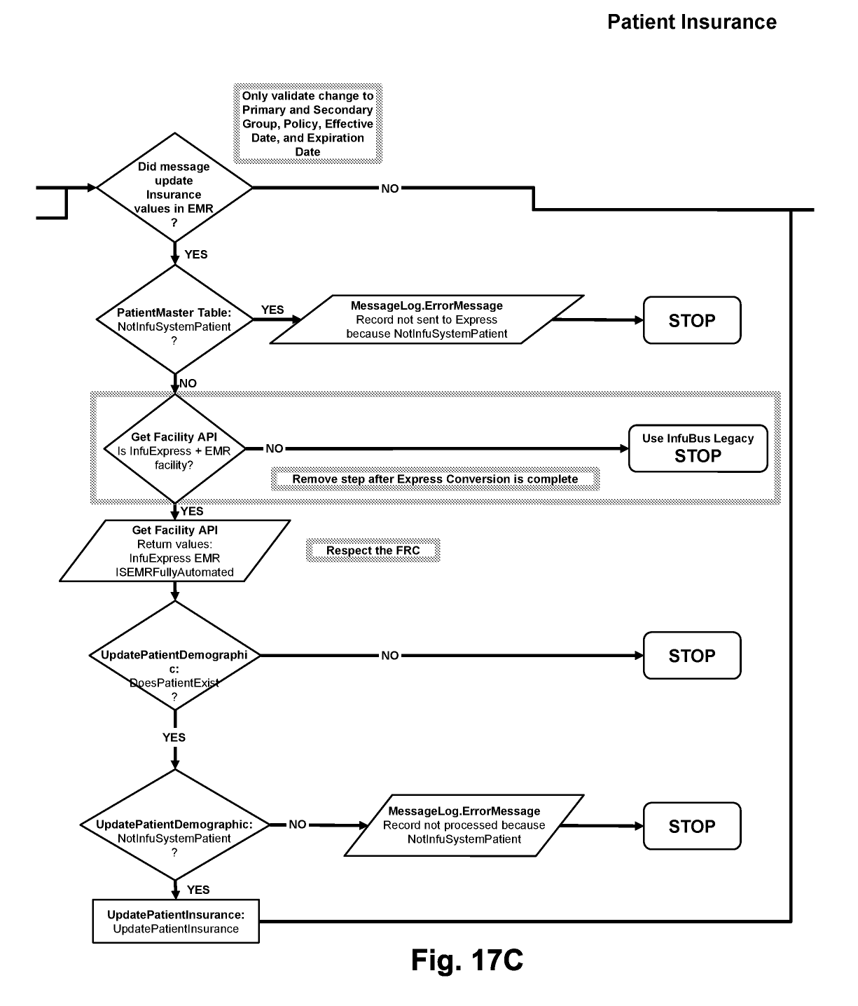

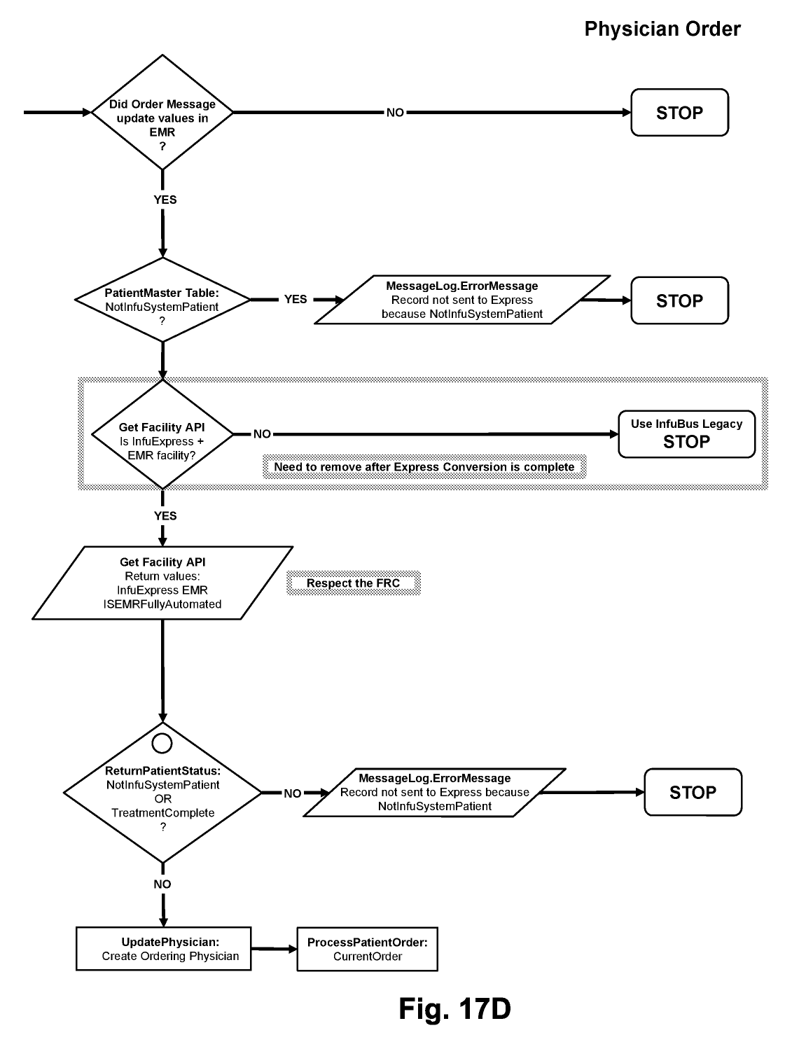

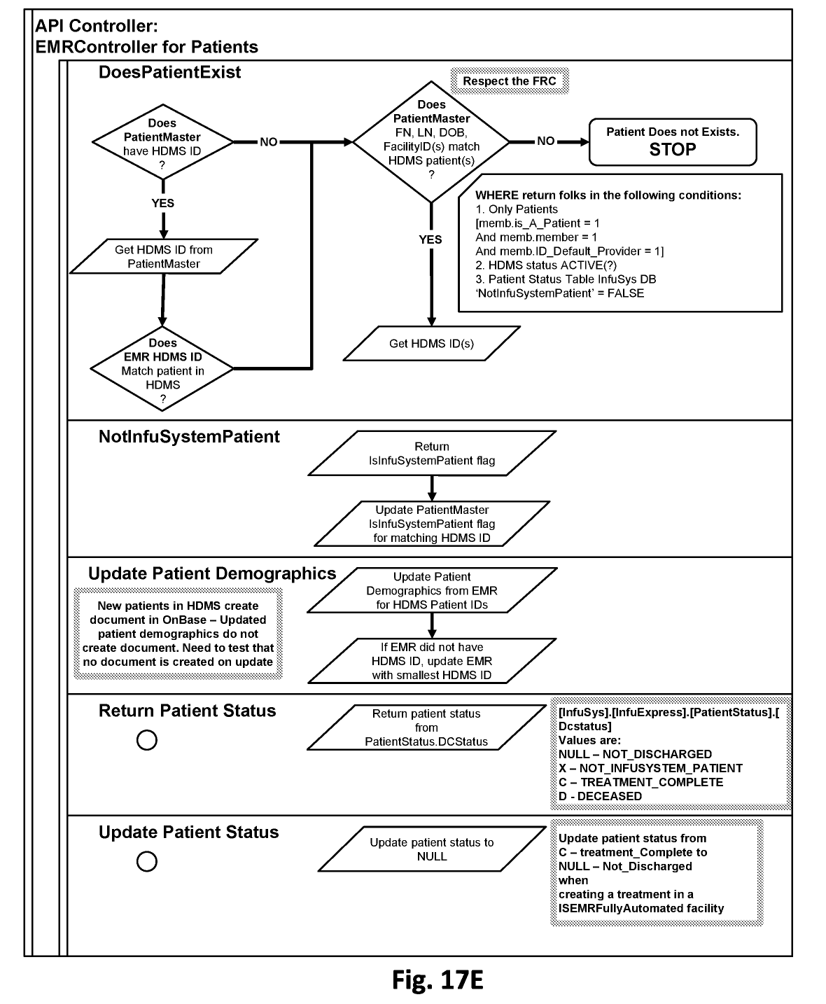

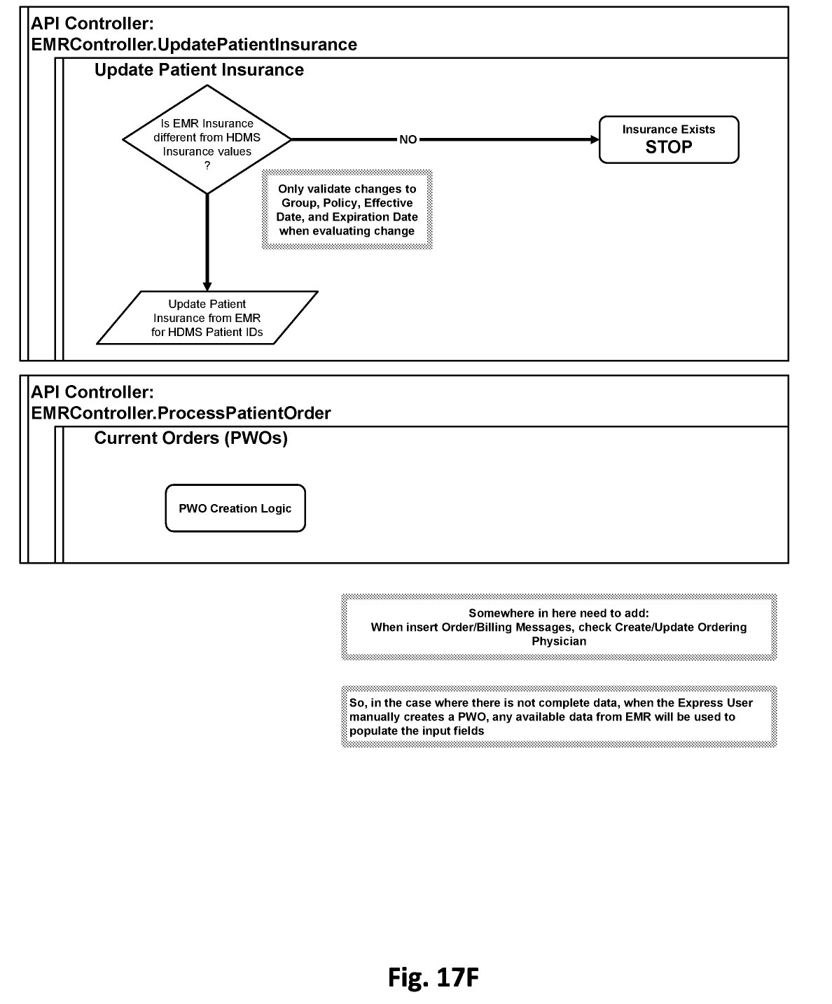

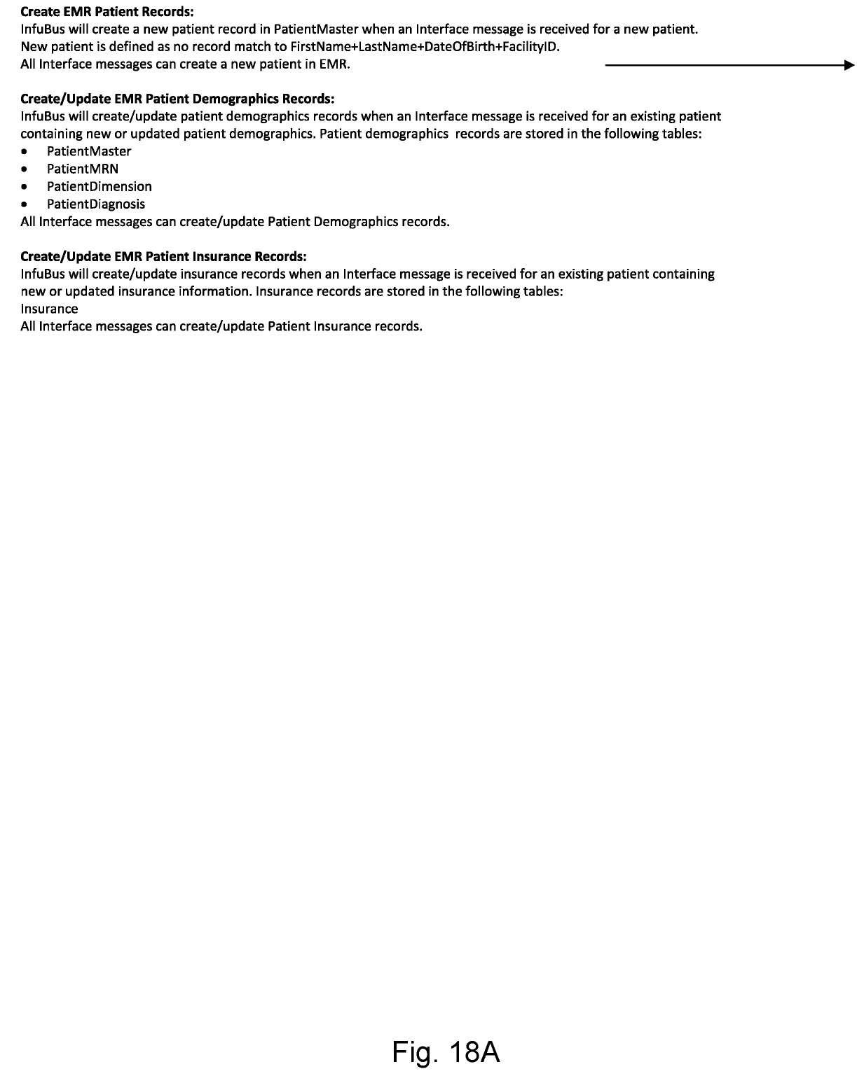

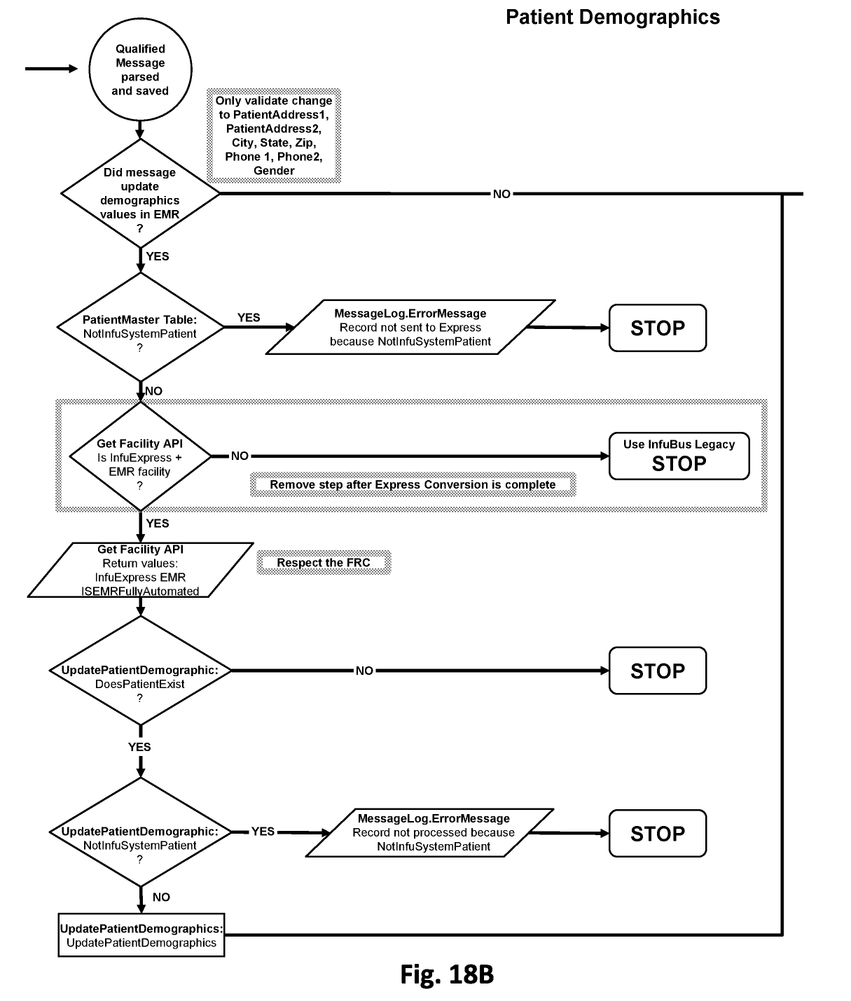

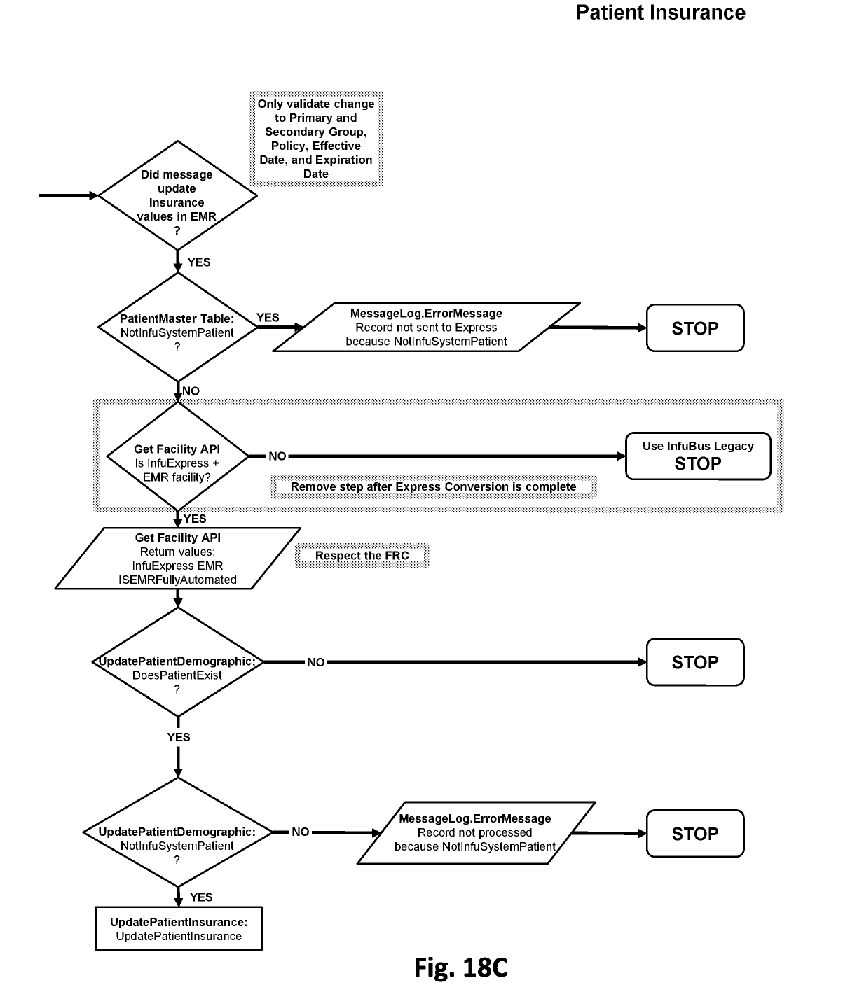

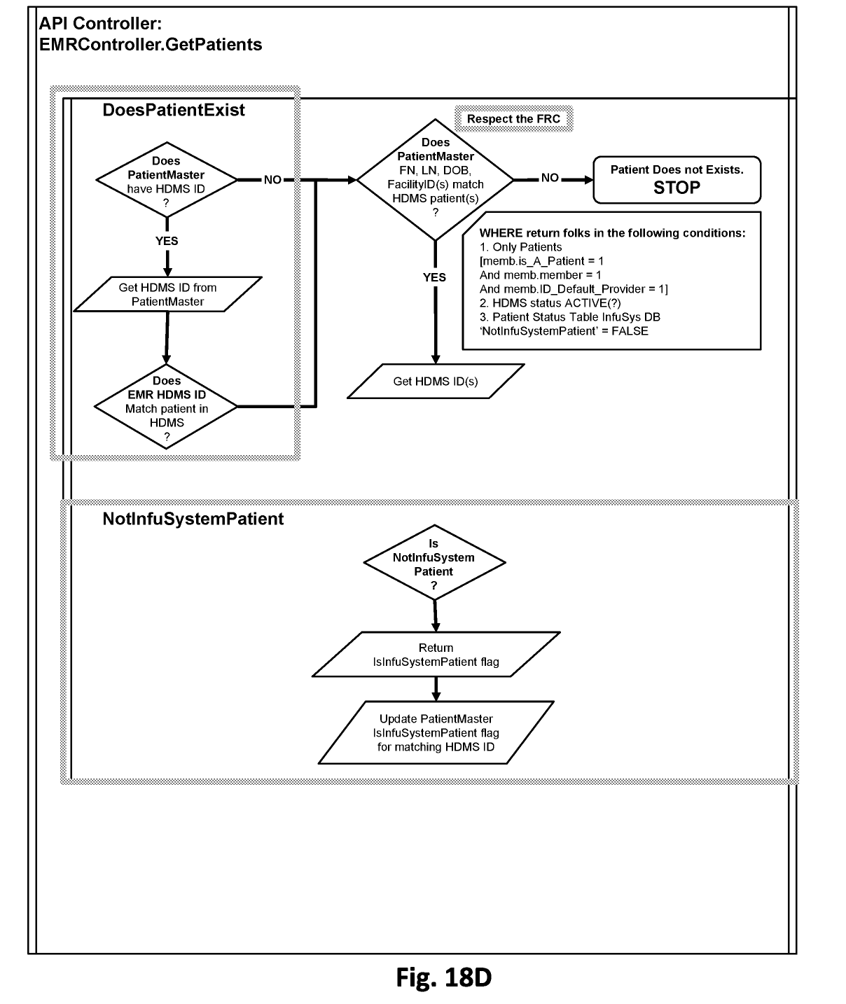

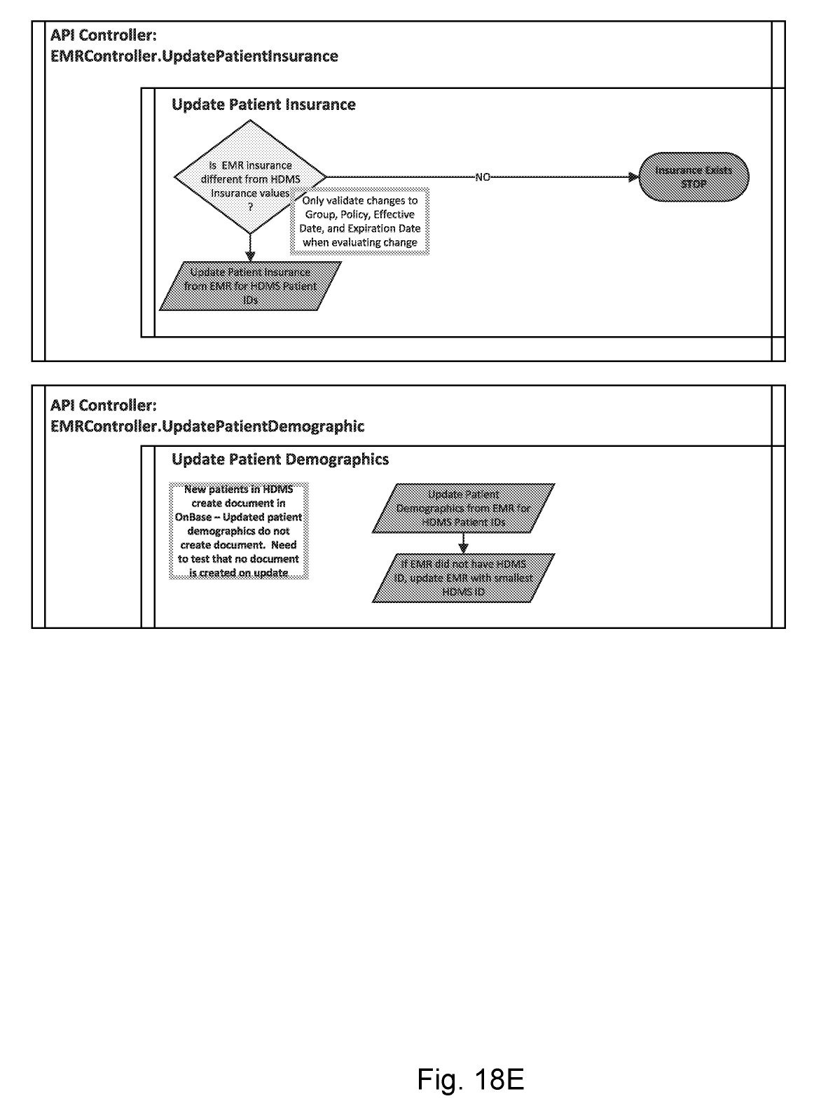

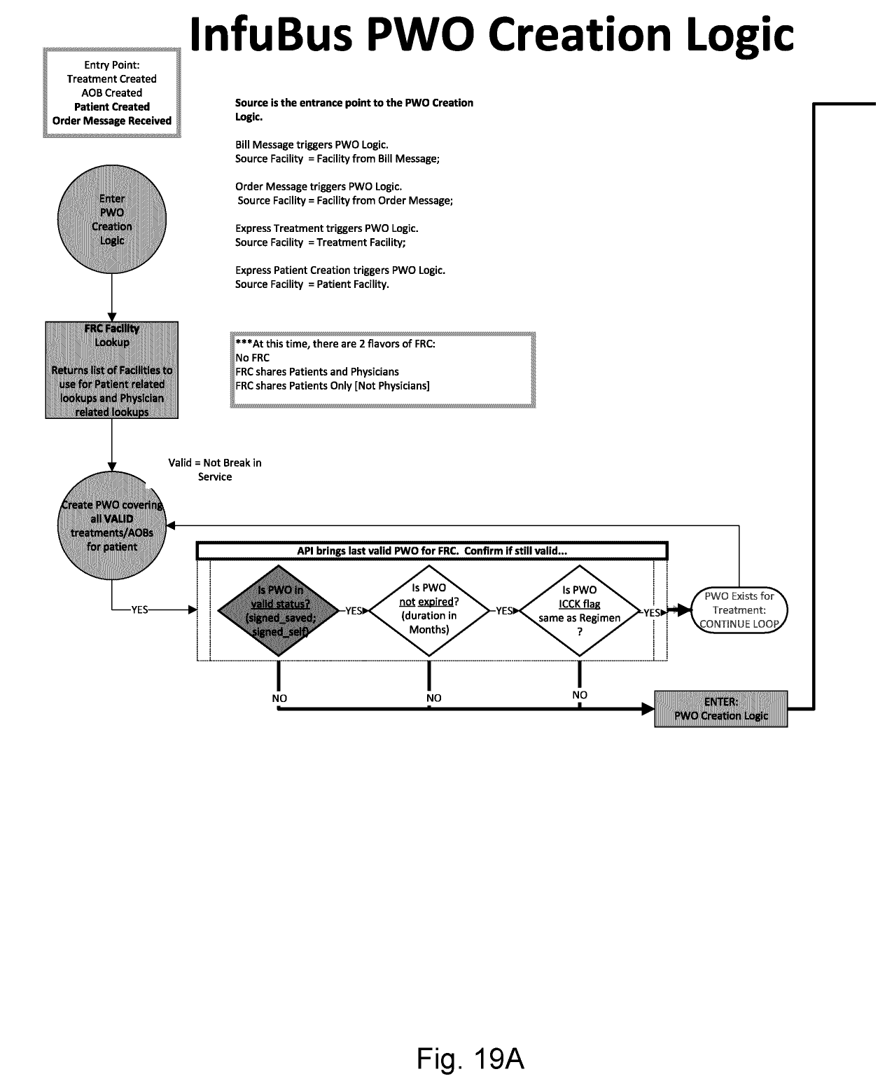

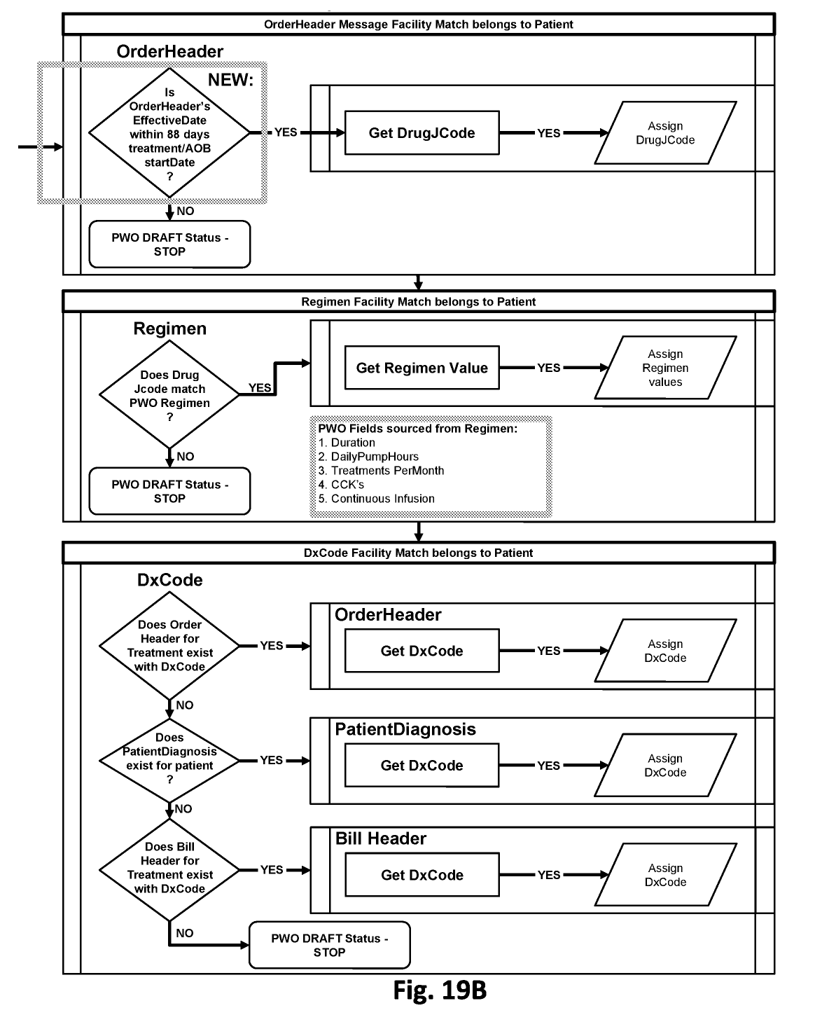

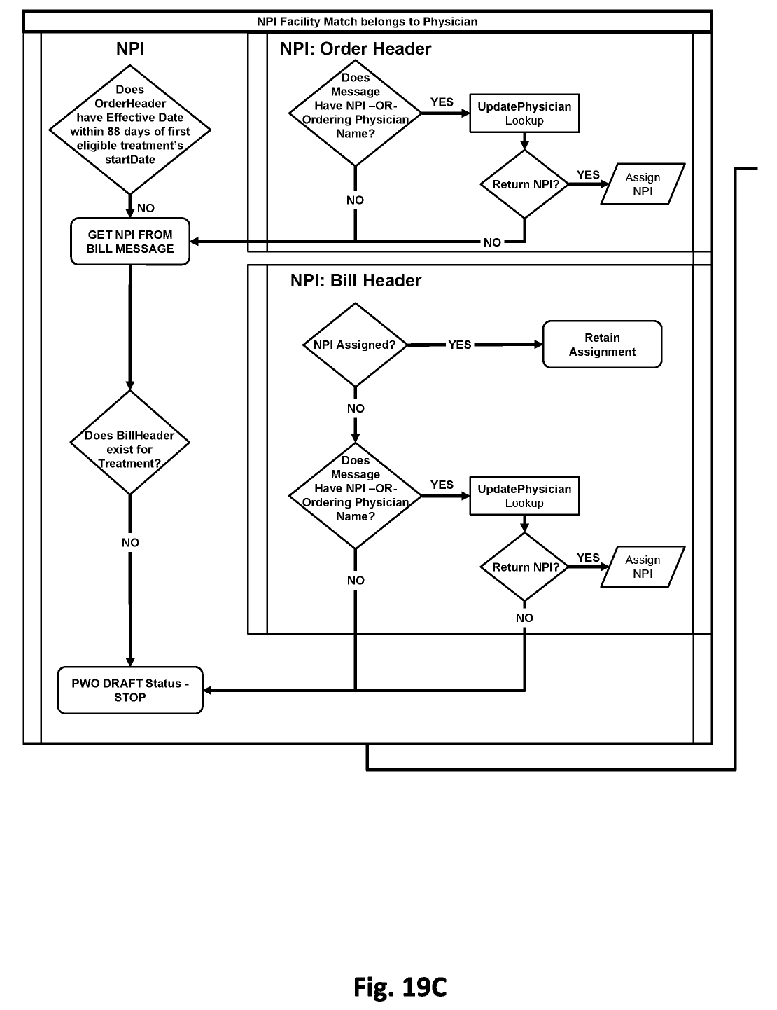

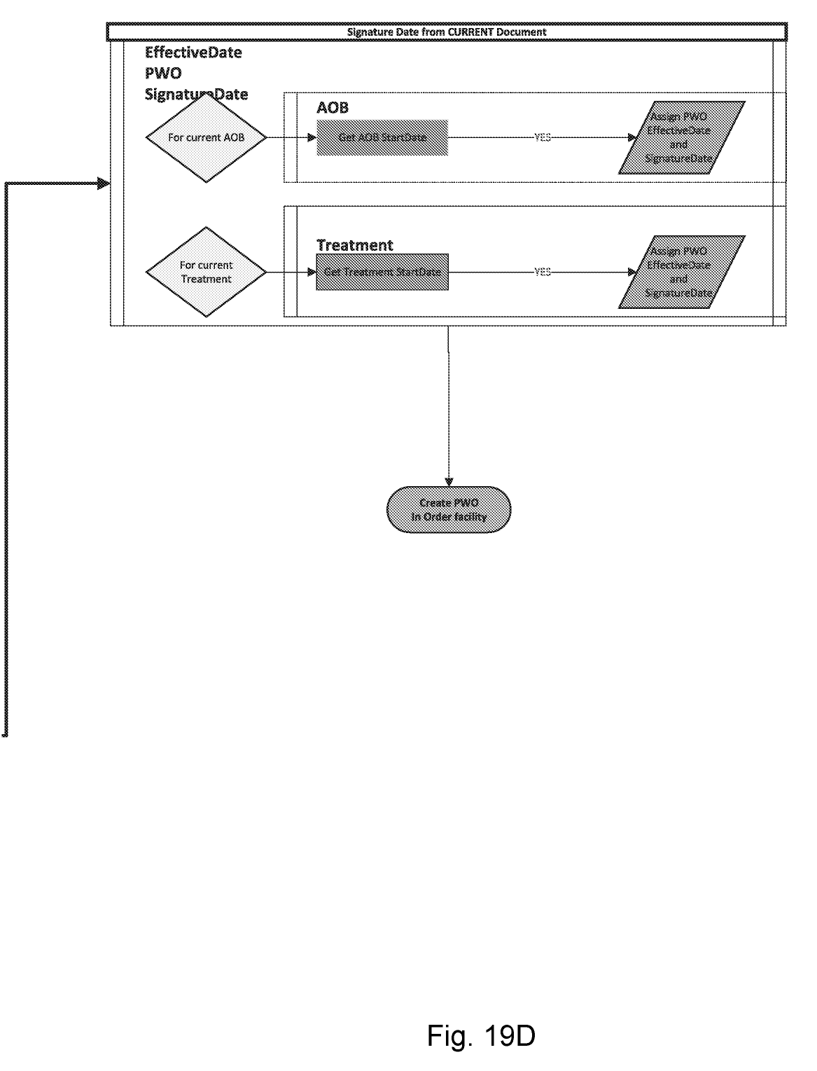

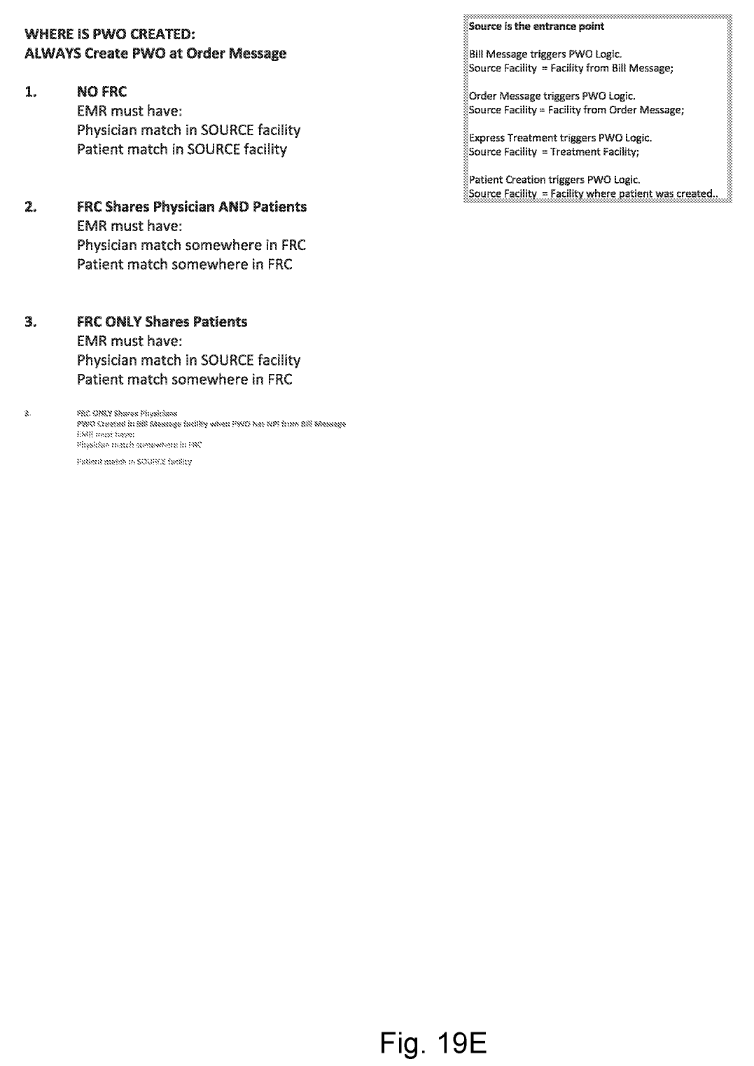

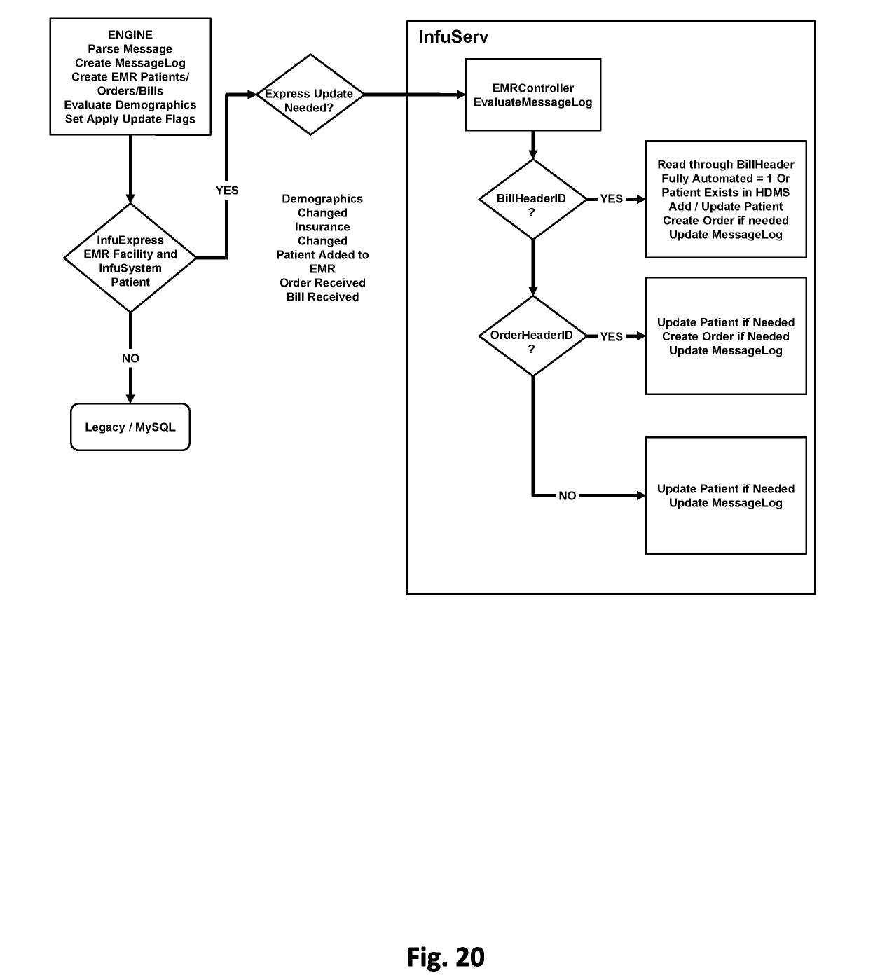

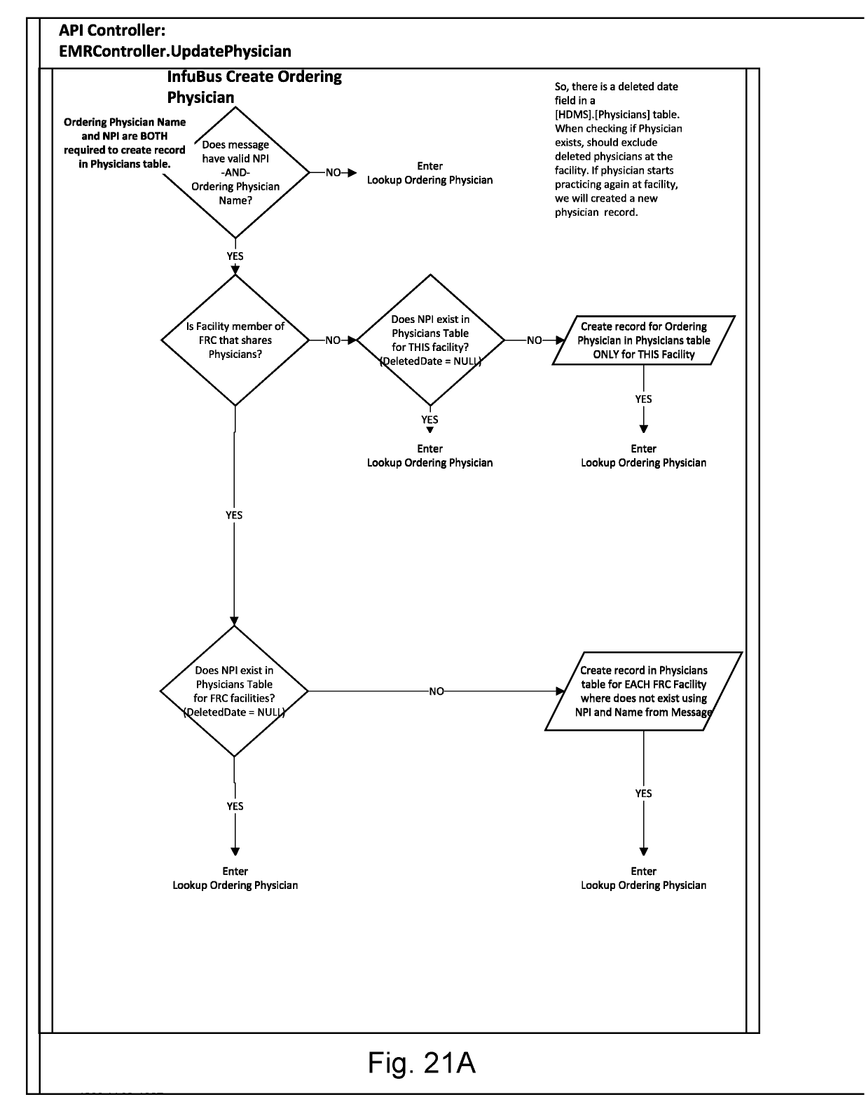

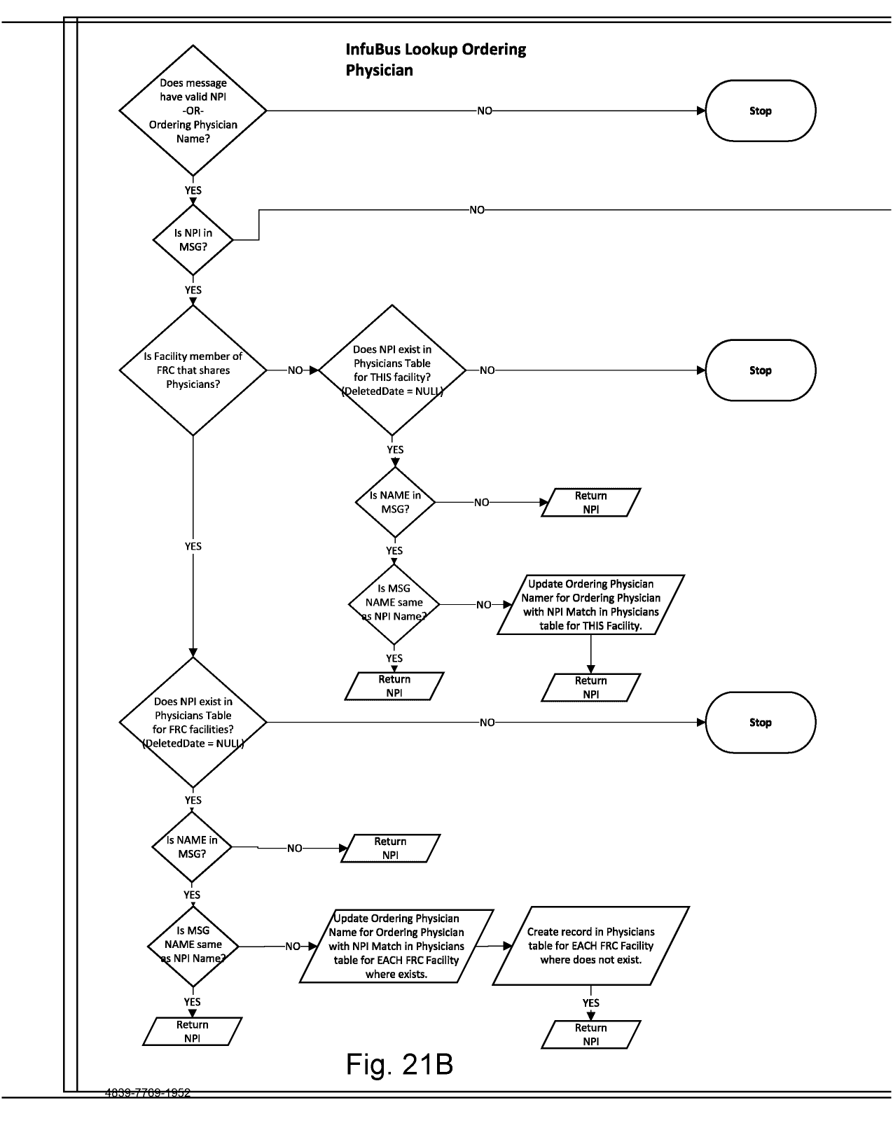

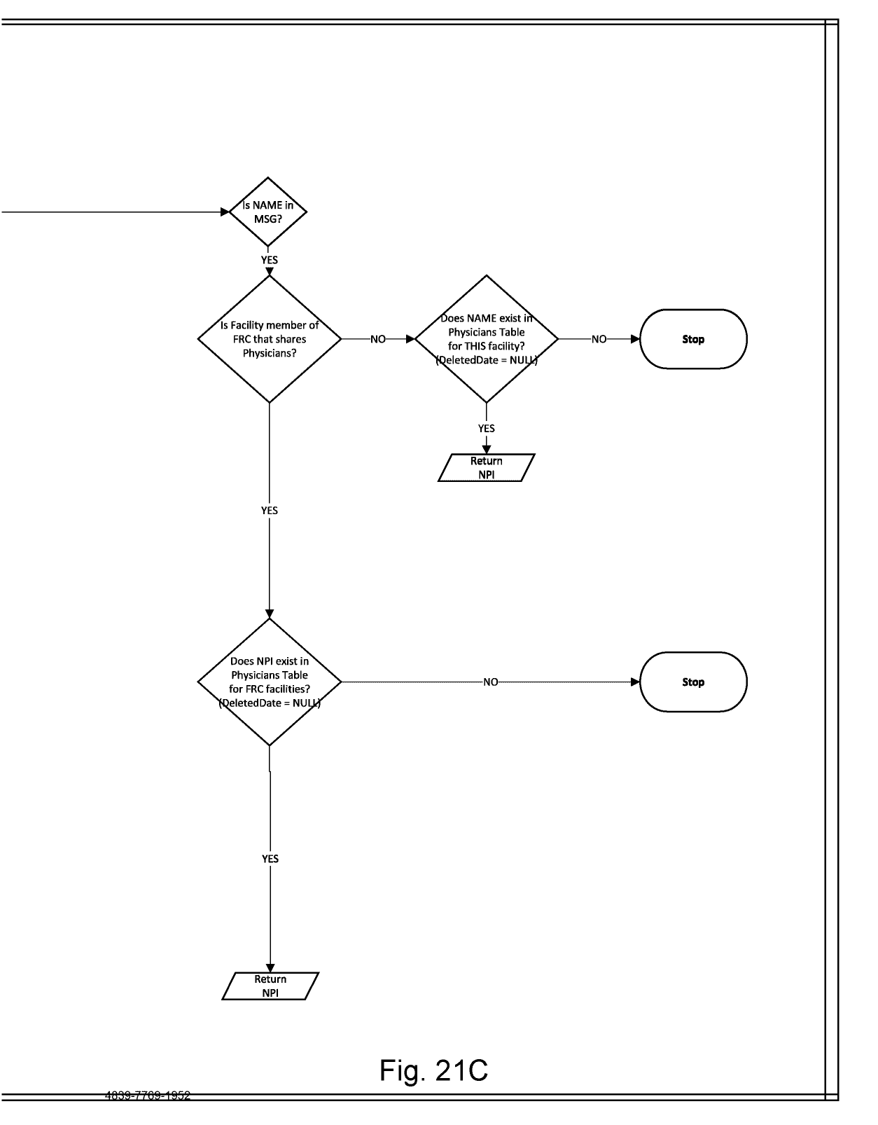

Referring to FIG. 13, some embodiments of the present invention include obtaining 210 RDE information, such as a Qualified Order Message and/or some other RDE Message 202. In some embodiments, the method further includes extracting 280 information pertaining to an ordering physician, such as the physicians name and/or NPI. In some such embodiments, the method further includes assessing 281whether the ordering physician is associated with an ordering facility, such as by the ordering physician's name and/or NPI being associated with a facility in a physician table, Physician Record 58, and/or Facility Record 56. In some such embodiments where the ordering physician is associated with the facility, the method further includes saving 282a physician information, such as the physician's name and/or NPI, in a database 50.

Still referring to FIG. 13, in some embodiments where the ordering physician is not associated with the facility, the method further includes assessing 283 whether the ordering physician information is valid, such as assessing whether the ordering physician NPI is valid. In some such embodiments where the ordering physician information is not valid, the method further includes saving 282b physician information, such as the physician's name and/or NPI, in a database 50. In other such embodiments where the ordering physician information is valid, the method further includes saving 282c physician information, such as the physician's name and/or NPI, in a database 50 and creating and/or updating 284 a record, such as a facility record 56 and/or a physician record 58.

### INFUTRACK™

The present invention also includes a tracking system for and method of tracking equipment, such as medical equipment. The tracking system comprises one or more data storage devices in data communication with one or more data processors and one or more user interfaces. In some embodiments, the user interface is a mobile device, such as a smartphone or a tablet.

In some embodiments of the present invention, a user links a particular piece of equipment, such as an infusion pump, with a particular user of the equipment, such as a patient. In some such embodiments, the tracking system receives information from the integration system so as to track the use of the equipment and/or to determine when the equipment is no longer needed. For instance, as a patient using the equipment is moved throughout a medical facility, the tracking system tracks the movement of the equipment by tracking the movement of the patient.

In some embodiments, the tracking system includes a means of generating a signal, such as an alert and/or one or more reports, when a piece of equipment is no longer needed. For instance, if a patient is released from a medical facility and/or dies, the tracking system receives that data from the ADT data feed and generates a signal indicating that the equipment should be retrieved. In this way, an owner of the equipment can be automatically notified when the equipment is available for retrieval so that the equipment is less likely to sit unattended for long periods of time. In some such embodiments, the tracking system further provides a retrieval location so that the owner can readily find the equipment. In other such embodiments, the tracking system maintains a history of each location the patient was in, when the patient was in the location, and how long the patient was in the location, so as to help determine where the equipment may be located if the equipment is not located at the retrieval location.

In other embodiments, the tracking system determines whether a particular piece of equipment has been located in a contamination zone and/or whether the equipment has potentially been contaminated. In such an embodiment, the tracking system provides one or more signals to an owner of the equipment indicating that the device should be sanitized and/or isolated. In this way, the system is capable of reducing the risk of cross-contamination with other pieces of equipment.

### INFULOCATE™

The present invention also includes a locating system for and method of locating equipment, such as medical equipment. The locating system comprises one or more data storage devices in data communication with one or more data processors and one or more user interfaces. In some embodiments, the user interface is a mobile device, such as a smartphone or a tablet. In some embodiments, a transponder is coupled to the equipment and a receiver is in data communication with at least one data processor. In some such embodiments, the transponder and receiver are each configured such that the transponder is capable of sending a signal that the receiver is capable of receiving. In other such embodiments, the transponder is pinged to determine the location of the equipment. In still other such embodiments, the transponder sends out an alert if the equipment is removed from a pre-determined area, such as a hospital facility. It will be appreciated that although a transponder and a receiver are specifically mentioned, it is contemplated that a variety of means of determining the location of one or more pieces of equipment can be utilized without changing the spirit or scope of the present invention.

In some embodiments, the locating system further includes a master map representing a predetermined area, such as a hospital facility. In some such embodiments, the master map indicates the location of one or more pieces of equipment. In other such embodiments, the master map automatically updates the location of one or more pieces of equipment as new location information is received for the equipment, such as from a transponder.

In some embodiments, the master map is a three-dimensional map. In other embodiments, the master map is a two-dimensional map. In some such embodiments, the master map includes additional information pertaining to a third dimension, such as which floor a piece of equipment is located on.

In some embodiments, the locating system maintains a location history for one or more pieces of equipment, including information pertaining to where the equipment was located, when the equipment was in the location, and how long the equipment was in the location. In this way, a user can more easily determine a chain of custody for the equipment and/or a sequence of what happened to the equipment.

The combination of the tracking system and the locating system can be used to customize one or more zones within a predetermined area, such as a medical facility. In this way, a user can more precisely track and manage a large number of pieces of equipment in a large area by designating a particular zone for one or more piece of equipment and monitoring when any of the pieces of equipment migrate out of their respective assigned zones.

Various embodiments of the computer program, devices, systems, and methods of the present invention are implemented in hardware, software, firmware, or combinations thereof using the system of the invention, which broadly comprises server devices, computing devices, and a communications network. Various embodiments of the server devices include computing devices that provide access to one or more general computing resources, such as Internet services, electronic mail services, and data transfer services, and the like. In some embodiments the server devices also provides access to a database that stores information and data, with such information and data including information and data necessary and/or desirable for the implementation of the computer program, devices, systems, and methods of the present invention.

Various embodiments of the server devices and the computing devices include any device, component, or equipment with a processing element and associated memory elements. In some embodiments the processing element implements operating systems, and in some such embodiments is capable of executing the computer program, which is also generally known as instructions, commands, software code, executables, applications (apps), and the like. In some embodiments the processing element includes processors, microprocessors, microcontrollers, field programmable gate arrays, and the like, or combinations thereof. In some embodiments the memory elements are capable of storing or retaining the computer program and in some such embodiments also store data, typically binary data, including text, databases, graphics, audio, video, combinations thereof, and the like. In some embodiments the memory elements also are known as a “computer-readable storage medium” and in some such embodiments include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, in some embodiments the server devices further include file stores comprising a plurality of hard disk drives, network attached storage, or a separate storage network.

Various embodiments of the computing devices specifically include communication devices (including wireless devices), work stations, desktop computers, laptop computers, palmtop computers, tablet computers, portable digital assistants (PDA), smart phones, wearable devices and the like, or combinations thereof. Various embodiments of the computing devices also include voice communication devices, such as cell phones or landline phones. In some preferred embodiments, the computing device has an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or pointing at display areas and/or via a keyboard or other input device to provide information to the user control interface.

In various embodiments the communications network will be wired, wireless, and/or a combination thereof, and in various embodiments will include servers, routers, switches, wireless receivers and transmitters, and the like, as well as electrically conductive cables or optical cables. In various embodiments the communications network will also include local, metro, or wide area networks, as well as the Internet, or other cloud networks. Furthermore, some embodiments of the communications network include cellular or mobile phone networks, as well as landline phone networks, public switched telephone networks, fiber optic networks, or the like.

Various embodiments of both the server devices and the computing devices are connected to the communications network. In some embodiments server devices communicate with other server devices or computing devices through the communications network. Likewise, in some embodiments, the computing devices communicate with other computing devices or server devices through the communications network. In various embodiments, the connection to the communications network will be wired, wireless, and/or a combination thereof. Thus, the server devices and the computing devices will include the appropriate components to establish a wired or a wireless connection.

Various embodiments of the computer program of the present invention run on computing devices. In other embodiments the computer program runs on one or more server devices. Additionally, in some embodiments a first portion of the program, code, or instructions execute on a first server device or a first computing device, while a second portion of the program, code, or instructions execute on a second server device or a second computing device. In some embodiments, other portions of the program, code, or instructions execute on other server devices as well. For example, in some embodiments information is stored on a memory element associated with the server device, such that the information is remotely accessible to users of the computer program via one or more computing devices. Alternatively, in other embodiments the information is directly stored on the memory element associated with the one or more computing devices of the user. In additional embodiments of the present invention, a portion of the information is stored on the server device, while another portion is stored on the one or more computing devices. It will be appreciated that in some embodiments the various actions and calculations described herein as being performed by or using the computer program will actually be performed by one or more computers, processors, or other computational devices, such as the computing devices and/or server devices, independently or cooperatively executing portions of the computer program.

A user of the computer program and/or protected application is capable of accessing various embodiments of the present invention via an electronic resource, such as an application, a mobile “app,” or a website. In certain embodiments, portions of the computer program are embodied in a stand-alone program downloadable to a user's computing device or in a web-accessible program that is accessible by the user's computing device via the network. For some embodiments of the stand-alone program, a downloadable version of the computer program is stored, at least in part, on the server device. A user downloads at least a portion of the computer program onto the computing device via the network. After the computer program has been downloaded, the program is installed on the computing device in an executable format. For some embodiments of the web-accessible computer program, the user will simply access the computer program via the network (e.g., the Internet) with the computing device.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, various embodiments of the present technology include a variety of combinations and/or integrations of the embodiments described herein.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A data collection system that is integrated with an EMR system, the data collection system comprising:
at least one data storage device;
at least one data processor in data communication with said at least one data storage device; and
at least one user interface in data communication with said at least one data storage device,
wherein the data collection system is configured to receive a plurality of data feeds from the EMR system, and
wherein the data collection system utilizes a search and retrieval algorithm to search through the data feeds and to retrieve additional information based on what is found in the data feeds.

2. The data collection system as claimed in claim 1, wherein the plurality of data feeds includes at least one of an ADT data feed, an RDE data feed, and a DFT data feed.

3. The data collection system as claimed in claim 1, wherein the search and retrieval algorithm includes logic for directing the data collection system to do one or more functions when the search and retrieval algorithm discovers information pertaining to a prescription for a medicine that requires one or more piece of medical equipment.

4. A method of collecting data from an EMR system, the method comprising:
receiving a plurality of data feeds from the EMR system, utilizing a search and retrieval algorithm to search through the data feeds; and
utilizing the search and retrieval algorithm to retrieve additional information based on what is found in the data feeds.

5. The method as claimed in claim 4, wherein the plurality of data feeds includes at least one of an ADT data feed, an RDE data feed, and a DFT data feed.

6. The method as claimed in claim 4, wherein the search and retrieval algorithm includes logic for directing the data collection system of claim 1 to do one or more functions when the search and retrieval algorithm discovers information pertaining to a prescription for a medicine that requires one or more piece of medical equipment.

7. An equipment tracking system for tracking one or more pieces of medical equipment, the system comprising:
at least one data storage device;
at least one data processor in data communication with said at least one data storage device; and
at least one user interface in data communication with said at least one data storage device,
wherein the equipment tracking system receives information from the data collection system of claim 1, and
wherein the one or more pieces of medical equipment are linked to one or more patient such that tracking the one or more pieces of medical equipment is accomplished by obtaining information through the data collection system pertaining to the one or more patient.

8. The equipment tracking system as claimed in claim 7, wherein the information pertaining to the one or more patient includes information pertaining to whether the patient has been prescribed medicine that requires use of the medical equipment.

9. The equipment tracking system as claimed in claim 7, wherein the information pertaining to the one or more patient includes information pertaining to whether the patient has been released from the hospital.

10. A method of tracking one or more pieces of medical equipment, the method comprising:
receiving information from the data collection system of claim 1;
linking the one or more pieces of medical equipment to one or more patient; and
obtaining information through the data collection system pertaining to the one or more patient.

11. The method as claimed in claim 10, wherein the information pertaining to the one or more patient includes information pertaining to whether the patient has been prescribed medicine that requires use of the medical equipment.

12. The method as claimed in claim 10, wherein the information pertaining to the one or more patient includes information pertaining to whether the patient has been released from the hospital.

13. An equipment locating system for locating one or more pieces of medical equipment, the system comprising:
at least one data storage device;
at least one data processor in data communication with said at least one data storage device;
at least one user interface in data communication with said at least one data storage device;
at least one display screen for displaying a master map showing the location of the one or more pieces of equipment relative a first area,
at least one receiver in data communication with said at least one data processor, said receiver being configured to receive a signal from a transponder; and
a transponder coupled to the medical equipment, the transponder being configured to send a signal that is capable of being received by said receiver,
wherein the signal is utilized by the data processor to determine the location of the one or more pieces of equipment, and
wherein the location of the one or more pieces of equipment are updated on the display screen automatically.

14. The equipment locating system as claimed in claim 13, wherein the data processor creates a signal if the one or more pieces of equipment migrates away from the first area.

15. The equipment locating system as claimed in claim 13, wherein the master map is a three-dimensional map.

16. The equipment locating system as claimed in claim 13, wherein the master map is a two-dimensional map with an indicator for distinguishing a relative location in a third dimension.

17. A method of locating one or more pieces of medical equipment, the method comprising:
coupling a transponder to the one or more pieces of medical equipment;
sending a signal from the transponder;
receiving the signal;
utilizing the signal to determine the location of the one or more pieces of equipment;
displaying a first area of a master map on a display screen;
displaying the location of the one or more pieces of equipment on the display screen such that the display screen shows the position of the one or more pieces of equipment relative to the first area of the master map; and
updating the location of the one or more pieces of equipment on the display screen automatically as the one or more pieces of equipment is moved from a first position to a second position.

18. The method as claimed in claim 17, further comprising generating a signal if the one or more pieces of equipment migrates away from the first area.

19. The method as claimed in claim 17, wherein the master map is a three-dimensional map.

20. The method as claimed in claim 17, wherein the master map is a two-dimensional map with an indicator for distinguishing a relative location in a third dimension.
